(19) United States
(12) Patent Application Publication
(10) Pub. No.: US 2024/0117196 A1
(43) Pub. Date: Apr. 11, 2024

(54) ANTIMICROBIAL COATING COMPOSITIONS

(71) Applicant: POLAROID IP B.V., Enschende (NL)

(72) Inventors: Stephen Robert Herchen, Plymouth, MA (US); Rong Chang Liang, Cupertino, CA (US); Christian Ewald Janssen, Recklinghausen (DE)

(73) Assignee: POLAROID IP B.V., Enschende (NL)

(21) Appl. No.: 18/371,358

(22) Filed: Sep. 21, 2023

Related U.S. Application Data
(63) Continuation of application No. PCT/US2022/020880, filed on Mar. 18, 2022.
(60) Provisional application No. 63/164,081, filed on Mar. 22, 2021.

(51) Int. Cl. C09D 5/14; A01N 47/12; A01P 1/00; C09D 179/02

(52) U.S. Cl. CPC C09D 5/14; A01N 47/12; A01P 1/00; C09D 179/02

(57) ABSTRACT

Described herein are quaternary ammonium polymers with broad spectrum antimicrobial properties that produce fast acting, long lasting, non-toxic and nonallergenic colorless and transparent durable surface coatings that are resistant to water and common solvents. The surface coatings are easy and cost effective to produce from readily-available materials using versatile synthesis, enabling a wide range of chemical variations. Such coatings are readily applicable to a wide range of surfaces and materials, without leaching of material from the coatings.

### CROSS-REFERENCE TO RELATED APPLICATIONS

This application is a continuation of International Patent Application No. PCT/US2022/020880, filed Mar. 18, 2022, which claims the benefit of priority to U.S. Provisional Patent Application No. 63/164,081, filed Mar. 22, 2021, the contents of each of which are hereby incorporated by reference herein in their entireties.

### FIELD

The embodiments of the present disclosure relate to broad spectrum antimicrobial coating compositions and methods of using the same. More specifically, embodiments of the present disclosure relate to quaternary ammonium polymers with broad spectrum antibacterial and antiviral properties.

### BACKGROUND

Infectious diseases including influenza kill millions of people globally per year and sicken hundreds of millions. During 2020, the world experienced a global COVID-19 pandemic caused by a highly transmissible novel coronavirus, severe acute respiratory syndrome coronavirus 2 (SARS-CoV-2).

The SARS-CoV-2 coronavirus, and other viruses before it, have been shown to be transmitted from person to person as airborne droplets but also by touching surfaces contaminated with the virus. A 2020 study done at two major urban U.S. hospitals¹ concluded that there was a 36% decline in healthcare-associated infections when commonly touched surfaces (keyboards, countertops, railings, chairs, etc.) were coated with a disinfectant. Indeed, disinfecting surfaces was adopted as a widespread health safety practice during the COVID-19 pandemic but with limited effectiveness because antiviral coatings become ineffective after a short time requiring costly and labor-intensive frequent re-application.

Over the years, there have been numerous antimicrobial polymers developed in an attempt to provide more effective antibacterial/antiviral surface coatings. A recent review by Jarach et al. (2020)² highlights some of the different polymer approaches to this problem. These polymers include nanoparticles with attached or adsorbed drugs, nanoparticles with embedded antiviral metals, naturally occurring polymers such as chitosan, silica particles with adsorbed quaternary ammonium salts and quaternary polyethyleneimines (PEI's).

An optimal antimicrobial surface coatings would have the following properties: (i) broad spectrum antimicrobial activity at a low Minimum Inhibition Concentration (MIC); (ii) fast acting; (iii) long lasting; (iv) non-toxic and nonallergenic; (v) no materials leaching out of the coating; (vi) acceptable color, transparency and appearance as a surface coating; (vii) easy application to a wide range of surfaces and materials; (viii) produces durable surface coating resistant to water, alcohol and common solvents; and (ix) easy and cost effective to produce.

As appreciated by the inventors of the present application, antimicrobial surface coatings in the prior art lack many of the above-listed characteristics. Accordingly, there is a need for improved antimicrobial surface coating compositions.

### SUMMARY

The embodiments of the present technology provide antimicrobial surface coatings with three or more of the following properties: (i) broad spectrum antimicrobial activity at a low Minimum Inhibition Concentration (MIC); (ii) fast acting; (iii) long lasting; (iv) non-toxic and nonallergenic; (v) no materials leaching out of the coating; (vi) acceptable color, transparency and appearance as a surface coating; (vii) easy application to a wide range of surfaces and materials; (viii) produces durable surface coating resistant to water, alcohol and common solvents; and (ix) easy and cost effective to produce. In some embodiments, the antimicrobial surface coatings of the present technology have four or more of these properties. In some embodiments, the antimicrobial surface coatings of the present technology have five or more of these properties. In some embodiments, the antimicrobial surface coatings of the present technology have six or more of these properties. In some embodiments, the antimicrobial surface coatings of the present technology have seven or more of these properties. In some embodiments, the antimicrobial surface coatings of the present technology have eight or more of these properties. In some embodiments, the antimicrobial surface coatings of the present technology have nine or more of these properties. In some embodiments, the antimicrobial surface coatings of the present technology have all of these properties.

In one aspect, provided herein is an antimicrobial composition comprising a polymer wherein: the polymer comprises a reaction product of a polyethyleneimine oligomer, a multifunctional crosslinker, an alkylating agent, an optional monoisocyanate and an optional catalyst; the polyethyleneimine oligomer comprises optionally substituted hydroxyethylene functionality that reacts with one of or both of the optional monoisocyanate or the multifunctional crosslinker; and nitrogen atoms present in the polyethyleneimine oligomer are at least partially quaternized by the alkylating agent.

In some embodiments, the hydroxyethylene functionality is optionally substituted with C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy. In some embodiments, the polyethyleneimine oligomer comprises a reaction product of a polyethyleneimine and a mono-epoxide, wherein the mono-epoxide is optionally substituted with C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy. In some embodiments, the mono-epoxide is a C₁-C₆ alkyl epoxide. In some embodiments, the C₁-C₆ alkyl epoxide is selected from the group consisting of propyl epoxide, butyl epoxide, and hexyl epoxide. In some embodiments, the polyethyleneimine has a molecular weight of about 600 to about 270,000 daltons, preferably a molecular weight of about 10,000 to about 200,000 daltons, and more preferably a molecular weight of about 25,000 to about 120,000 daltons. In some embodiments, the polyethyleneimine is branched. In some embodiments, the polyethyleneimine is hyperbranched. In some embodiments, the polyethyleneimine has a ratio of primary to secondary to tertiary amines of about 1:2:1 to about 1:1:1. In some embodiments, the polyethyleneimine has a ratio of primary to secondary to tertiary amines of about 1:1:0.7. In some embodiments, the multifunctional crosslinker is a polyisocyanate. In some embodiments, the polyisocyanate has an average isocyanate functionality of 2 to 5, preferably an average isocyanate functionality of 3 or 4. In some embodiments, the polyisocyanate is prepared from diisocyanates selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI). In some embodiments, the polyisocyanate is selected from the group consisting of DESMODUR® N-3300, DESMODUR® N-100, DESMODUR® Z4470SN, WANNATE® T series polyisocyanates, and LUPRANATE® M series polyisocyanates. In some embodiments, at least 75% of the nitrogen atoms of the polyethyleneimine oligomer are quaternized by the alkylating agent. In some embodiments, the alkylating agent comprises one or more R₂-LG, wherein each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy; and each LG is a leaving group. In some embodiments, the alkylating agent is benzyl halide or hexyl halide. In some embodiments, the monoisocyanate comprises one or more R₃-NCO, wherein each R₃ is independently selected from (1) C₆-C₂₀ alkyl optionally substituted with 1-3 substituents independently selected from halogen, —SiRₐ(OR_{b})(OR_{c}), and C₆-C₁₀ aryl; and (2) C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and —Si(C₁-C₆ alkyl)₃. In some embodiments, the monoisocyanate comprises octylisocyanate, octadecylisocyanate, or a combination thereof. In some embodiments, at least 20%, preferably at least 45%, even more preferably at least 75% of the optionally substituted hydroxyethylene functionality reacts with the monoisocyanate and no more than 25%, preferably no more than 10% of the optionally substituted hydroxyethylene functionality reacts with the polyisocyanate. In some embodiments, the polymer comprises a reaction product of the polyethyleneimine oligomer, the multifunctional crosslinker, the alkylating agent, and optionally the catalyst, in the absence of the monoisocyanate. In some embodiments, the optional catalyst comprises dibutyl tin dilaurate or bismuth carboxylate.

In another aspect, provided herein is an antimicrobial composition comprising compound (IV):

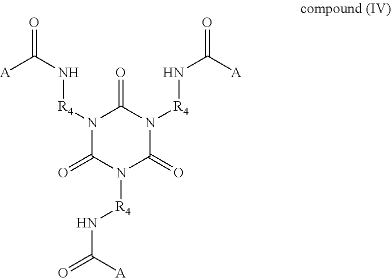

wherein:
each A is independently selected from

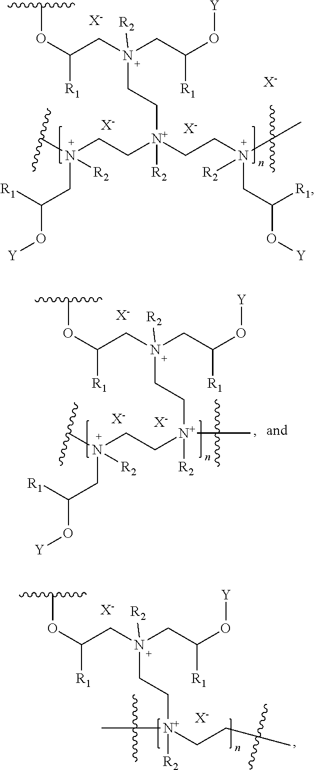

or a copolymer of any two or more thereof; and attachment of each A forms a carbamate linkage;
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; (2) C₆-C₁₀ aryl optionally substituted with 1-3 substituents independently selected from halogen, C₁-C₆ alkyl, and —SiRₐ(OR_{b})(OR_{c}); and (3)

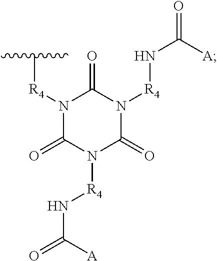

wherein each Rₐ is independently C₁-C₆ alkyl; and each R_{b} and each R_{c} are independently selected from C₁-C₆ alkyl and —Si(C₁-C₆ alkyl)₃;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In some embodiments of compound (IV), at least 75% but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆alkyl)₃. In some embodiments of compound (IV), each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments of compound (IV), R₃ is octyl, octadecyl, or a combination thereof. In some embodiments of compound (IV), each R₃ is independently selected from C₆-C₁₀ aryl optionally substituted with 1-3 substituents independently selected from halogen, C₁-C₆ alkyl, and —SiRₐ(OR_{b})(OR_{c}). In some embodiments of compound (IV), R₃ is

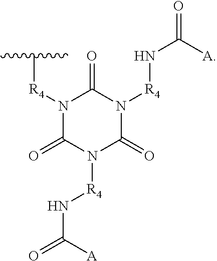

In another aspect, provided herein is an antimicrobial composition comprising compound (V):
wherein:

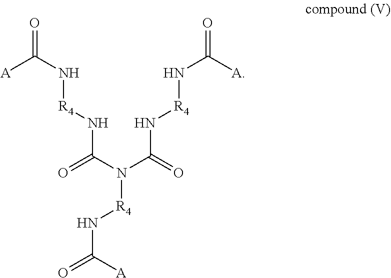

each A is independently selected from

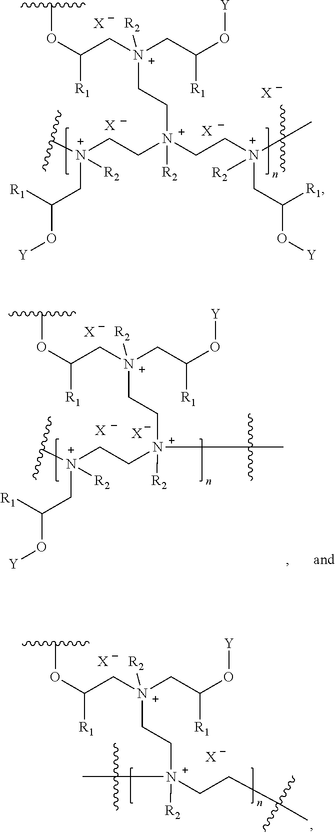

or a copolymer of any two or more thereof; and attachment of each A forms a carbamate linkage;
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; (2) C₆-C₁₀ aryl optionally substituted with 1-3 substituents independently selected from halogen, C₁-C₆ alkyl, and —SiRₐ(OR_{b})(OR_{c}); and (3)

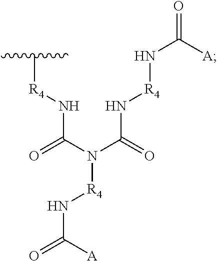

wherein each Rₐ is independently C₁-C₆ alkyl; and each R_{b} and each R_{c} are independently selected from C₁-C₆ alkyl and —Si(C₁-C₆ alkyl)₃;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In some embodiments of compound (V), at least 75% but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆ alkyl)₃. In some embodiments of compound (V), each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments of compound (V), R₃ is octyl, octadecyl, or a combination thereof. In some embodiments of compound (V), each R₃ is independently selected from C₆-C₁₀ aryl optionally substituted with 1-3 substituents independently selected from halogen, C₁-C₆ alkyl, and —SiRₐ(OR_{b})(OR_{c}). In some embodiments of compound (V), R₃ is

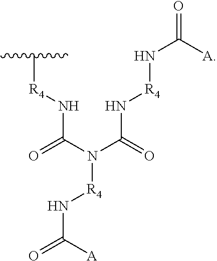

In some embodiments of compound (IV) or compound (V), each R₁ is independently C₁-C₆ alkyl. In some embodiments of compound (IV) or compound (V), each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy. In some embodiments of compound (IV) or compound (V), each R₂ is independently selected from methyl, butyl, hexyl, benzyl, —CH₂C(O)Ph, and —CH₂C(O)OCH₂CH₃. In some embodiments of compound (IV) or compound (V), R₄ is C₁-C₁₀ alkylene optionally substituted with phenyl. In some embodiments of compound (IV) or compound (V), R₄ is C₁-C₁₀ alkylene. In some embodiments of compound (IV) or compound (V), R₄ is a 3- to 8-member cycloalkyl ring.

In another aspect, provided herein is an antimicrobial composition comprising compound (VI), compound (VII), or compound (VIII):

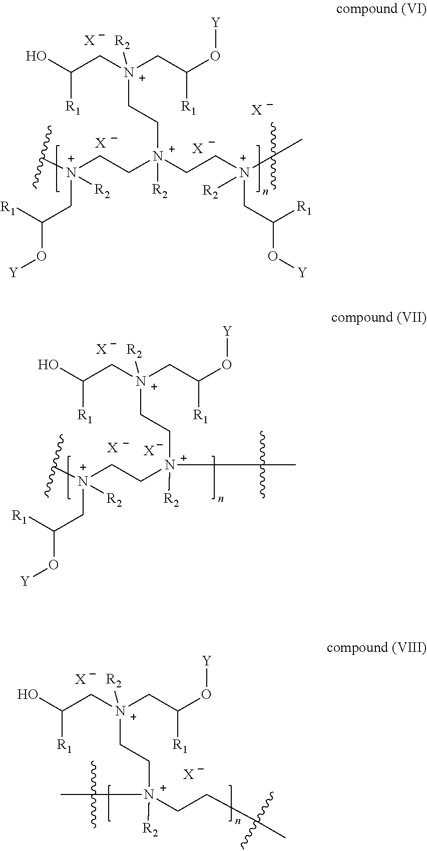

or a combination of any two or more thereof, or a copolymer of any two or more thereof,
wherein:
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; and (2) C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In some embodiments of compound (VI), compound (VII) or compound (VIII), each R₁ is independently C₁-C₆ alkyl. In some embodiments of compound (VI), compound (VII) or compound (VIII), each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy. In some embodiments of compound (VI), compound (VII) or compound (VIII), each R₂ is independently selected from methyl, butyl, hexyl, benzyl, —CH₂C(O)Ph, and —CH₂C(O)OCH₂CH₃. In some embodiments of compound (VI), compound (VII) or compound (VIII), at least 75% but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆ alkyl)₃. In some embodiments of compound (VI), compound (VII) or compound (VIII), each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments of compound (VI), compound (VII) or compound (VIII), R₃ is octyl, octadecyl, or a combination thereof. In some embodiments of compound (VI), compound (VII) or compound (VIII), each R₃ is independently selected from C₆-C₁₀ aryl optionally substituted with 1-3 substituents independently selected from halogen, C₁-C₆ alkyl, and —SiRₐ(OR_{b})(OR_{c}).

In another aspect, the antimicrobial surface coatings of the present technology comprise Mono-Urethane substituted Alkyl Quaternary Polyethyleneimine (PEI)-A (MUA-Q-PEI-A) that is formed by reacting at least one monoisocyanate with Hydroxyl Alkyl Quaternary PEI (HA-Q-PEI). In some embodiments, 20% to 100% of the hydroxyl group of the HA-Q-PEI are converted to urethane group by reacting with at least one monoisocyanate. In some embodiments, 50% to 95% of the hydroxyl group of the HA-Q-PEI are converted to urethane group by reacting with at least one monoisocyanate. In some embodiments, the monoisocyanate is selected from alkyl-, alkylaryl-, arylalkyl- or aryl-monoisocyanate. In some embodiments, the monoisocyanate is a blend of octylisocyanate and octadecylisocyanate. In some embodiments, the molar ratio of octylisocyanate to octadecylisocyanate is from 1/9 to 5/5. In some embodiments, the molar ratio of octylisocyanate to octadecylisocyanate is from 2/8 to 4/6. In some embodiments, the monoisocyanate is a fluoro- or organosilicone-substituted monoisocyanate. In some embodiments, the polyethyleneimine has an average molecular weight between 600 and 1,000,000. In some embodiments, the polyethyleneimine has an average molecular weight between 25,000 and 270,000. In some embodiments, the polyethyleneimine is a linear, branched, hyperbranched polyethyleneimine or their blend. In some embodiments, the MUA-Q-PEI-A has a counterion selected from halides, sulfate, sulfonate, phosphate, carbonate, and borate. In some embodiments, the counterion is chloride, bromide, iodide or sulfate. In some embodiments, the reactant HA-Q-PEI is formed by reacting polyethyleneimine with a mono-epoxide and quaternizing with a quaternizing agent. In some embodiments, the mono-epoxide is an alkyl epoxide. In some embodiments, the alkyl epoxide is selected from propyl, butyl, or hexyl epoxide. In some embodiments, the alkyl epoxide is propyl epoxide. In some embodiments, the quaternizing agent is an alkyl halide or arylalkyl halide. In some embodiments, the quaternizing agent is benzyl halide or hexyl halide.

In another aspect, the antimicrobial surface coatings of the present technology comprise cross-linked Polyurethane Alkyl Quaternary PEI-B (PUA-Q-PEI-B) formed by crosslinking the above-described HA-Q-PEI with at least one polyisocyanate. In some embodiments, the polyisocyanate has an average isocyanate functionality of 2 to 5. In some embodiments, the polyisocyanate has an average isocyanate functionality of 3 to 4. In some embodiments, the polyisocyanate is prepared from diisocyanates selected from hexamethylene diisocyanate (HDI), isophorone diisocyanate (I PDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), or trimethylhexamethylene diisocyanate (TM DI). In some embodiments, the polyisocyanate is an isocyanate-end-capped oligomer prepared from a multifunctional isocyanate and a polyol. In some embodiments, the polyol is selected from polyester polyol, polyether polyol, polysiloxane polyol, polycaprolactone polyol, or polybutadiene polyol.

In another aspect, the antimicrobial surface coatings of the present technology comprise a cross-linked Polyurethane Alkyl Quaternary PEI-C (PUA-Q-PEI-C), wherein the PUA-Q-PEI-C is formed by reacting at least one polyisocyanate with HA-Q-PEI. In some embodiments, the polyisocyanate has an average isocyanate functionality of 2 to 5. In some embodiments, the polyisocyanate has an average isocyanate functionality of 3 to 4. In some embodiments, the polyisocyanate is prepared from diisocyanates selected from hexamethylene diisocyanate (HDI), isophorone diisocyanate (I PDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), or trimethylhexamethylene diisocyanate (TM DI). In some embodiments, the polyisocyanate is an isocyanate-end-capped oligomer prepared from a multifunctional isocyanate and a polyol. In some embodiments, the polyol is selected from polyester polyol, polyether polyol, polysiloxane polyol, polycaprolactone polyol, or polybutadiene polyol.

In another aspect, the present technology provides an antimicrobial coating, coating fluid or spraying fluid comprising any of the above-described antimicrobial compositions. In some embodiments, the HA-Q-PEI, MUA-Q-PEI-A, PUA-Q-PEI-B or PUA-Q-PEI is water soluble, water dispersible, alcohol soluble or alcohol dispersible. In some embodiments, the coating fluid or spraying fluid is water soluble, water dispersible, alcohol soluble or alcohol dispersible. In some embodiments, the device, equipment, apparatus or accessory is selected from a filter, an air purifier, mask or other personal protection device (PPD), respirator, etc. In some embodiments, the device, equipment, apparatus or accessory is selected from a keyboard, a keypad, a mouse, a remote controller, a touch screen, a phone or a display or any device integrating any of the foregoing components.

In another aspect, the present technology provides a personal care aid comprising any of the above-described coating, coating fluid or spraying fluid. In some embodiments, the coating fluid or spraying fluid is water soluble, water dispersible, alcohol soluble or alcohol dispersible.

In another aspect, provided herein is a method to sanitize a surface, the method comprising applying a composition described herein. In another aspect, provided herein is a method to reduce antimicrobial growth on a surface, the method comprising applying a composition described herein. In another aspect, provided herein is a method to prevent antimicrobial growth on a surface, the method comprising applying a composition described herein. In some embodiments, the method further comprises forming a coating solution containing the composition. In some embodiments, the method further comprises directing the coating solution to a surface, and providing a coating on the surface through the application of the coating solution to the surface.

Other implementations are also described and recited herein.

### BRIEF DESCRIPTION OF THE DRAWINGS

For the purpose of illustration, certain embodiments of the present technology are shown in the drawings described below. It should be understood, however, that the technology is not limited to the precise arrangements, dimensions, and instruments shown. In the drawings:

FIG. 1 shows the structure of starting polyethyleneimine (PEI) and the resulting Hydroxy Alkyl Quaternary PEI (HA-Q-PEI) polymer following a reaction with an alkyl epoxide followed by quaternization with an alkylating agent.

FIG. 2 shows the structure of starting HA-Q-PEI and the resulting mono-urethane-substituted alkyl quaternary PEI-A (MUA-Q-PEI-A) following a reaction with one or a blend of hydrophobic monoisocyanates.

FIG. 3 shows the structure of mono-urethane-substituted alkyl quaternary PEI-A100 (MUA-Q-PEI-A100) once 100% of the free hydroxyl groups are reacted.

FIG. 4 provides one of the structures of a cross-linked Polyurethane Alkyl Quaternary PEI-B (PUA-Q-PEI-B).

FIG. 5 provides one of structures of a cross-linked polymer network of Polyurethane Alkyl Quaternary PEI-C (PUA-Q-PEI-C).

FIG. 6A and FIG. 6B depict the RT-qPCR test with FIG. 6A showing the setup of a test plate and FIG. 6B illustrating the QuantStudio 3 PCR procedure.

FIG. 7 shows a test plate used for the assessment of the antiviral properties of Composition (III).

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present technology. It may be evident, however, that the present technology may be practiced without these specific details. In other instances, well- known structures and devices are shown in block diagram form in order to facilitate describing the present technology. It is to be appreciated that certain aspects, modes, embodiments, variations and features of the technology are described below in various levels of detail in order to provide a substantial understanding of the present technology.

### Definitions

For convenience, the meaning of some terms and phrases used in the specification, examples, and appended claims, are provided below. Unless stated otherwise, or implicit from context, the following terms and phrases include the meanings provided below. The definitions are provided to aid in describing particular embodiments, and are not intended to limit the claimed subject-matter, because the scope of the present technology is limited only by the claims. Unless otherwise defined, all technical and scientific terms used herein have the same meaning as commonly understood by one of ordinary skill in the art to which this present technology belongs. If there is an apparent discrepancy between the usage of a term in the art and its definition provided herein, the definition provided within the specification shall prevail.

As used in this specification and the appended claims, the singular forms “a,” “an” and “the” include plural referents unless the content clearly dictates otherwise. For example, reference to “a cell” includes a combination of two or more cells, and the like.

As used herein, the term “approximately” or “about” in reference to a value or parameter are generally taken to include numbers that fall within a range of 5%, 10%, 15%, or 20% in either direction (greater than or less than) of the number unless otherwise stated or otherwise evident from the context (except where such number would be less than 0% or exceed 100% of a possible value). As used herein, reference to “approximately” or “about” a value or parameter includes (and describes) embodiments that are directed to that value or parameter. For example, description referring to “about X” includes description of “X”.

As used herein, the term “or” means “and/or.” The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the term “comprising” means that other elements can also be present in addition to the defined elements presented. The use of “comprising” indicates inclusion rather than limitation.

The term “consisting of” refers to compositions, methods, and respective components thereof as described herein, which are exclusive of any element not recited in that description of the embodiment.

As used herein the term “consisting essentially of” refers to those elements required for a given embodiment. The term permits the presence of additional elements that do not materially affect the basic and novel or functional characteristic(s) of that embodiment of the present technology.

As used herein, “aryl” refers to a carbocyclic (all carbon) ring that is fully aromatized. An “aryl” group can be made up of two or more fused rings (rings that share two adjacent carbon atoms). When an aryl group is a fused ring system, then the ring that is connected to the rest of the molecule is fully aromatized. The other ring(s) in the fused ring system may or may not be fully aromatized. Examples of aryl groups include, without limitation, the radicals of benzene, naphthalene and azulene.

As used herein, “alkyl” refers to a straight or branched chain fully saturated (no double or triple bonds) hydrocarbon group. An alkyl group of the presently disclosed compounds may comprise from 1 to 15 carbon atoms. An alkyl group herein may have 1 to 4 carbon atoms, 1 to 5 carbon atoms, 1 to 6 carbon atoms, 1 to 7 carbon atoms, 1 to 8 carbon atoms, 1 to 9 carbon atoms, 1 to 10 carbon atoms, 1 to 11 carbon atoms, 1 to 12 carbon atoms, 1 to 13 carbon atoms, 1 to 14 carbon atoms, or 1 to 15 carbon atoms. As used herein, a C₁-C₆ alkyl represents an alkyl group having 1 to 6 carbon atoms, a C₁-C₄ alkyl represents an alkyl group having 1 to 4 carbon atoms and a C₁-C₃ alkyl represents an alkyl group having 1 to 3 carbon atoms, etc. Examples of alkyl groups include, without limitation, methyl, ethyl, n-propyl, isopropyl, n-butyl, i-butyl, sec-butyl, t-butyl, amyl, t-amyl, hexyl, heptyl, octyl, nonyl, decyl, undecyl and dodecyl.

As used herein, “alkoxy” refers to an alkyl group, as defined above, appended to the parent molecular moiety through an oxy group, —O—. As used herein, a C₁-C₆ alkoxy represents an alkoxy group containing 1 to 6 carbon atoms and a C₁-C₃ alkoxy represents an alkoxy group containing 1 to 3 carbon atoms. Representative examples of alkoxy include, but are not limited to, methoxy, ethoxy, propoxy, 2-propoxy, butoxy, tert-butoxy, pentyloxy, hexyloxy etc.

As used herein, unless otherwise stated, “independently selected” indicates that each one of a designated group is selected independently from a subsequent list of species.

The term “statistically significant” or “significantly” refers to statistical significance and generally means a two standard deviation (2SD) or greater difference.

The terms “decrease”, “reduced”, “reduction”, or “inhibit” are all used herein to mean a decrease by a statistically significant amount. In some embodiments, “reduce,” “reduction” or “decrease” or “inhibit” typically means a decrease by at least 10% as compared to a reference level (e.g., the absence of a given treatment or agent) and can include, for example, a decrease by at least about 10%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, at least about 99% , or more. As used herein, “reduction” or “inhibition” does not encompass a complete inhibition or reduction as compared to a reference level. “Complete inhibition” is a 100% inhibition as compared to a reference level. A decrease can be preferably down to a level accepted as within the range of normal for an individual without a given disorder.

The terms “increased”, “increase”, “enhance”, or “activate” are all used herein to mean an increase by a statically significant amount. In some embodiments, the terms “increased”, “increase”, “enhance”, or “activate” can mean an increase of at least 10% as compared to a reference level, for example an increase of at least about 20%, or at least about 30%, or at least about 40%, or at least about 50%, or at least about 60%, or at least about 70%, or at least about 80%, or at least about 90% or up to and including a 100% increase or any increase between 10-100% as compared to a reference level, or at least about a 2-fold, or at least about a 3-fold, or at least about a 4-fold, or at least about a 5-fold or at least about a 10-fold increase, or any increase between 2-fold and 10-fold or greater as compared to a reference level. In the context of a marker or symptom, an “increase” is a statistically significant increase in such level.

As used herein, the term “quaternary ammonium polymer antiviral compositions” generally represents the family of quaternary ammonium polymer compositions wherein the tertiary nitrogen moieties being quaternized using alkylating agents such as benzyl chloride.

As used herein, the term “polyethylenimine” generally represents the family of polymers containing primary, secondary and tertiary amino groups such as PEI 70 KDa (aka average molecular weight).

As used herein, the term “monoisocyanates” generally represents the family of monoisocyanates which are hydrophobic in nature such as alkyl, aryl, alkylaryl or arylalkyl monoisocyanates, preferably mono-isocyanates having a carbon number ≥6, more preferably ≥8. Useful examples include, but are not limited to octadecylisocyanate, dodecylisocyanate and octylisocyanate.

As used herein, the term “polyisocyanates” generally represents the family of polyisocyanates containing more than one isocyanate reactive group such as, but not limited to, DESMODUR® N3300 and N100 (made by Covestro Deutschland AG of Leverkusen, Germany) which is an aliphatic polyisocyanate based on HDI (hexamethylene diisocyanate) trimer, or DESMODUR® Z4470SN (made by Covestro Deutschland AG of Leverkusen, Germany) which is a multifunctional polyisocyanate based on IPDI (isophorone diisocyanate).

As used herein, the term “antimicrobial” is used generally to indicate at least some level of microbe kill by a composition or a coating on a portion of a surface. For example, antimicrobial may be used to indicate a biostatic efficacy, sanitizing level (3-log, or 99.9%) reduction in at least one organism, or a disinfection level (5-log, or 99.999%) reduction in at least one organism, or sterilization (no detectable organisms). Microbes, or microorganisms, may include any species of bacteria, virus, fungus including mold and yeast, or spore. Thus, antimicrobial herein encompasses antiviral, antibacterial and antifungal.

As used herein, the terms “residual antimicrobial,” “residual self-sanitizing,” and “self-decontaminating surface” are used interchangeably to indicate a surface that maintains antimicrobial efficacy over a certain period of time under certain conditions once the surface is coated with an antimicrobial coating composition and that composition dried on the surface as a thin film. A coated surface may maintain residual antimicrobial efficacy indefinitely, or the coating may eventually “wear out” and lose its residual antimicrobial efficacy. An antimicrobial coating composition may function as a contact sanitizer, bacteriostatic material, disinfectant, or sterilant (e.g., as a liquid antimicrobial applied to a contaminated surface) and may also have the ability to leave behind a residual antimicrobial coating on the surface once dried or cured thereon that can keep inactivating new microorganisms that contact the coated surface. In various embodiments, coating compositions may not be antimicrobial until dried or cured on a surface but are still referred to as antimicrobial coating compositions because of their ability to produce a residual antimicrobial coating on a surface. Antimicrobial coating compositions for use in various embodiments may provide a residual antimicrobial efficacy to a surface, meaning that a microorganism later inoculated on, or that otherwise comes in contact with, the coated surface may experience cell death, destruction, or inactivation. The residual antimicrobial effect made possible by the coatings herein is not limited by a particular mechanism of action, and no such theories are proffered. For example, an antimicrobial effect measured on a surface may be the result of intracellular mutations, inhibition of certain cellular processes, rupture of a cell wall, or a nondescript inactivation of the organism, such as in the case of viruses. Other antimicrobial effects may include inhibiting the reproduction of an organism or inhibiting the organism's ability to accumulate into biofilms.

As used herein, the term “antimicrobial coating composition” refers to a chemical composition comprising at least one chemical species, which is used to produce a residual antimicrobial coating on a surface after the composition is applied and then either dried, allowed to dry, or cured in some manner. The term is also used for liquid compositions that may find use as a germicidal spray (disinfectant or sanitizer), since the composition could then go on to dry into an antimicrobial coating. The term is also extended to include a composition that may be applied sequentially (e.g., over or under) or contemporaneously with the application of an antimicrobial coating composition, such as to assist in bonding the residual antimicrobial coating to the surface, improve durability of the overall coating, and/or to provide a catalytic effect or some sort of potentiation or synergy with the residual antimicrobial coating comprising an antimicrobial active. For simplicity herein, each one of multiple compositions used sequentially or contemporaneously to produce an overall residual antimicrobial coating on a portion of a surface is referred to as an “antimicrobial coating composition,” even if one or more of the compositions used for coating has no identifiable antimicrobial activity or where the active agent is uncertain. An antimicrobial coating composition may comprise a neat, 100% active chemical species or may be a solution or suspension of a single chemical species in a solvent. In other aspects, a composition may comprise a complex mixture of chemical substances, some of which may chemically react (hydrolyze, self-condense, etc.) within the composition to produce identifiable or unidentifiable reaction products. For example, a monomeric chemical species in an antimicrobial coating composition may partially or fully polymerize or copolymerize, such as to produce polymers including homopolymer and copolymers with a distribution of molecular weight, comonomer ratio, or molecular architecture while in solution, prior to a coating process using that composition. In other embodiments, chemical constituents within an antimicrobial coating composition may chemically react, graft or form an interpenetration network on the surface or interphase that the composition is applied to, such as while the composition is drying and concentrating on the surface or while the coating composition is cured by various methods. In various embodiments, a solution comprising a polymer distribution may polymerize or cure further, such as to longer chain lengths or forming a polymer network, while the solution dries on a surface. Antimicrobial coating compositions for use in various embodiments may further comprise any number and combination of inert excipients, such as for example, solvents, buffers, acids, alkali, surfactants, emulsifiers, stabilizers, UV absorbers, thickeners, free-radical initiators, fillers, pigments or colorants, catalysts, etc.

As used herein, the term “homopolymer” takes on its ordinary meaning in organic chemistry of a molecule having repeated and identical monomer units. For simplicity's sake, the term homopolymer herein includes each of the smaller oligomers, i.e., dimer, trimer, tetramer, dendrimers, dendrons, etc., unless specified otherwise. For example, a homopolymer distribution herein may include the dimer and above, or the trimer and above, as indicated. In some instances, a homopolymer chain length distribution may be well defined and characterized, and in other instances, the distribution may not be characterizable at all and may remain unknown. The term copolymer herein includes random copolymer, block copolymer, graft copolymer, interpolymer complex, interpenetration network, etc . . . and their blends.

As used herein, the term “wt. %” takes on the ordinary meaning of percent (%) by weight of an ingredient in a chemical composition, based on the total weight of the composition “as made.” For example, an aqueous composition comprising 1 wt. % amine “based on the total weight of the composition” equates to a composition containing 99.0 grams water and 1.0 gram amine. Wt. % in a composition indicates the wt. % of active material, unless indicated otherwise. “As made” means that a written composition shows what was added to a mixing vessel, and not what might end up in the mixture after certain ingredients react, such as if an ingredient hydrolyzes or polymerizes.

Unless otherwise defined herein, scientific and technical terms used in connection with the present application shall have the meanings that are commonly understood by those of ordinary skill in the art to which this disclosure belongs. It should be understood that this present technology is not limited to the particular methodology, protocols, and reagents, etc., described herein and as such can vary. The terminology used herein is for the purpose of describing particular embodiments only and is not intended to limit the scope of the present technology, which is defined solely by the claims. Definitions of common terms in immunology and molecular biology can be found in The Merck Manual of Diagnosis and Therapy;³ The Encyclopedia of Molecular Cell Biology and Molecular Medicine;⁴ Molecular Biology and Biotechnology: a Comprehensive Desk Reference;⁵ Immunology;⁶ Janeway's Immunobiology;⁷ Lewin's Genes XI;⁸ Molecular Cloning: A Laboratory Manual.;⁹ Basic Methods in Molecular Biology;¹⁰ Laboratory Methods in Enzymology;¹¹ Current Protocols in Molecular Biology (CPMB);¹² Current Protocols in Protein Science (CPPS);¹³ and Current Protocols in Immunology (CPI).¹⁴

Other terms are defined herein within the description of the various aspects of the present technology.

### Antimicrobial Coatings

Surfaces of objects which are in direct or indirect contact with humans and animals are exposed to a high microbial load and have a demonstrable influence on the transmission of diseases and infections. The antimicrobial coatings of the present technology can be particularly useful because they can be applied to just about any surface and drastically reduce the microbial load. Surfaces that can be treated with antimicrobial coatings include, but are not limited to, interior and exterior building components such as handrails, fixtures, fixture knobs, pulling handles, and grips; parts such as faucet handles for kitchens, wash rooms, bathrooms, toilets, personal articles, telephones, computers, door handles, counters, furniture, walls, ticketing machines, high-touch areas (e.g., lounges of buildings, public means of payment, and public means of transport), and other tough-to-clean/access areas such as mechanicals and HVAC systems. Further, these coatings have applicability to medical devices and accessories, implants, and instruments, laboratory equipment, factories, water filtration equipment, hospitals, school/childcare facilities, airports, restaurants, gyms, etc.

Bacteria of particular concern include, but are not limited to, Staphylococcus aureus (Staph), Escherichia coli (E. coli), Methicillin-Resistant Staphylococcus aureus (MRSA) and Vancomycin-Resistant Enterococcus faecalis and Enterobacter aerogenes (VRE). Staph is a group of over 30 strains that cause many different types of infections, including skin infections, food and blood poisoning. Most strains of E. coli are not harmful but are part of the healthy bacterial flora in the human gut. However, some strains can cause various diseases, including pneumonia, urinary tract infections, diarrhea and meningitis. Some strains of E. coli can also cause nausea, vomiting and fever. MRSA is a type of bacterium that causes infections in different parts of the body. It is relatively more difficult to treat than most other strains of Staph because it is resistant to antibiotics. It can cause serious skin, bloodstream, lungs or urinary tract infections. VRE are a type of bacteria called Enterococci that have developed resistance to many antibiotics, especially Vancomycin as the name suggests. These bacteria can cause serious infections, especially in people who are already ill, weak, and/or immunocompromised. VRE may cause bloodstream infection (sepsis), urinary infection, pneumonia, heart infections (endocarditis), or meningitis.

Viruses of particular concern include, but are not limited to, influenza A and B viruses, respiratory syncytial virus, adenovirus, rhinovirus and coronaviruses (229E, HKU1, NL63, 0043, and, more recently, SARS-CoV-2) as these viruses have been demonstrated to have long survival periods on numerous surfaces. For example, in a recent study of airports,¹⁵ detection of pathogen viral nucleic acids demonstrated viral surface contamination at multiple sites associated with high touch rates and suggested a potential risk in standard passenger pathways at airport sites. These viruses can cause serious infections, especially in people who are already ill, weak, and/or immunocompromised.

In the chemical coatings industry, a 99.9% percent reduction in bacteria or virus translates to a three order of magnitude reduction in microbial risk (i.e., 3 log). However, there is a number of physical and chemical requirements that an antimicrobial coating should meet to be a fully effective and broadly applicable antiviral/antibacterial/antifungal agent and surface coating. These properties include:
1. Highly antimicrobial against a broad spectrum of viruses, bacteria, and fungi.
2. Very fast-acting; killing greater than 99.9% of viruses in a contact time of ten minutes or less and of bacteria after overnight.
3. Long lasting; maintaining a bacteria or virus killing efficiency of at least 98% after 100 days of storage under ambient conditions or after 72 hours of storage at 40° C./85% RH humidity.
4. Non-toxic and nonallergenic based on recognized standard test procedures.
5. No materials leached out over time or when exposed to typical liquids used for cleaning.
6. Visibly colorless and transparent as a surface coating.
7. Easy to apply to a wide range of surfaces and materials by painting, spraying, dipping or other commonly used application methods.
8. Durable surface coating that is resistant to delaminating from the surface or becoming visibly deteriorated by contact with water, alcohol and common solvents.
9. Easy and cost effective to produce from readily available materials.
10. Made by a synthesis that is versatile enabling a wide range of chemical variations to fine tune its properties (i.e., solubility, etc.) for a range of different applications.
   To the present inventors' knowledge there are no antimicrobial coatings available yet that meet most or all of these requirements. Many of the existing antimicrobial coatings tend to deteriorate with time and lose effectiveness as contamination is repeated.

Conventional coating products claiming to deliver antibacterial properties include PAINTGUARD/PAINTSHIELD® from the Sherwin Williams Company (Cleveland, Ohio); ALESTA® AM and ALESTA® Ralguard from Axalta (Philadelphia, PA) and SILVERSAN™ from PPG Industrial Coatings (Pittsburgh, PA). However, these products generally claim to be 99.9% effective, but take over 5 hours after application to reach their maximum efficiency. Further, existing solutions tend to degrade over time, so that their active performance goes below 90% after recontamination (i.e., repeated exposure to pathogens in combination with routine environmental exposure and/or scrubbing/cleaning over prolonged periods of time). At just 90% protection, bacteria and germs have the ability to grow and respire, eventually multiplying to the point where existing pathogens on the substrate layer will persist, thereby decreasing the efficacy of these coatings.

Antimicrobial polymers have been reported with embedded agents including metals like silver,¹⁶ but these suffer from the fact that the embedded antimicrobial agents can leach out over time causing the polymer coating to lose its antimicrobial activity. Moreover, such formulations are not entirely satisfactory, as they only lead to a 3 log reduction that fails to completely inhibit regrowth of bacteria. This lack of effectiveness can probably be attributed to the fact that silver is used insufficient amounts and/or is unevenly dispersed throughout the composition, resulting in an inconsistent and, ultimately, ineffective distribution of anti-microbial particles within the composition/coating.

Park et al. (2006)¹⁷ reported antimicrobial active polymers made by reacting polyethyleneimine with a hydrophobic long chain hydrocarbon alkylating agent and then quaternization by methylation. Although these polymers have antibacterial and antiviral activity as surface coatings, the coatings are not colorless, and they are not durable and resistant to contact with water and other common solvents to which the surface may regularly come in contact.

Many have speculated that the antiviral activity of quaternary ammonium polymers is due to the interaction between the hydrophobic quaternary ammonium groups and the negatively charged membrane of the virus causing a disruption of the membrane which inactivates microorganisms such as viruses. In fact, the active ingredients in many of the commercially-available antiviral surface sprays are low molecular weight quaternary ammonium surfactant-like materials, which are assumed to act by this mechanism but that do not form long lasting durable surface coatings.

Researchers have reported acrylic or methacrylic co-polymers with quaternary ammonium functional groups that have antimicrobial activity^{18,19} but these do not produce durable water and solvent resistant coatings, and some have exhibited a level of toxicity.

Several researchers have reported antimicrobial polyurethane polymers bearing quaternary ammonium functional groups^{20,21,22} but these have a number of shortcomings. Some are water soluble and thereby not suitable for durable surface coatings. Others do not report testing the durability of coatings or the toxicity of the materials. Some are rather tedious to synthesize requiring somewhat expensive materials and as many as four synthetic steps including amine blocking and deblocking reactions.

Gao et al. (2007)²³ have reported the synthesis and antibacterial activity of polymers synthesized by alkylating polyethyleneimine with propyl epoxide and then quaternizing with benzyl chloride. These polymers are reported to be highly antibacterial with contact times as short as 4 minutes, but they are water soluble and thereby not suitable for producing a durable surface coating. Furthermore, testing against viruses and toxicity was not reported for these polymers.

While antimicrobial quaternary ammonium compounds and polymers are previously known, simple coatings of these materials either are not optically clear or not highly antimicrobial or not durable and simple steps to cross-link the coatings to achieve durability are insufficient to simultaneously achieve these properties.

### Polymers of the Present Technology

The specific polymer chemistry according to the present techniques is new and novel in that non-obvious chemical modifications to the basic polyethyleneimine quaternary ammonium polymer structure were developed to optimize the polymer's overall properties by controlling polymer molecular weight, the nature of the polymer quaternary ammonium groups, the use of hydroxyalkylated PEI hydroxyl groups to fine-tune the polymer's hydrophilic-hydrophobic properties by partial reaction with selected monoisocyanates, as well as controlling the type and degree of polymer cross-linking to produce coatings that have the above-described properties and, more specifically, that simultaneously exhibit both high antimicrobial efficiency and good durability.

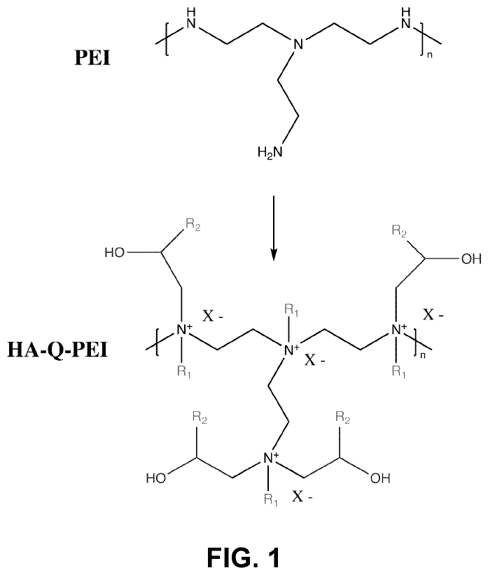

In one aspect, provided herein are several novel quaternary ammonium polymers that meet virtually all of the requirements listed above. The general process to produce these polymers starts with reacting polyethyleneimine (PEI) in a one-pot reaction with an alkyl epoxide followed by quaternization with an alkylating agent to produce polymers of the general structure in FIG. 1, referred to as Hydroxy Alkyl Quaternary PEI (HA-Q-PEI). These polymers are, in general, water soluble or water dispersible.

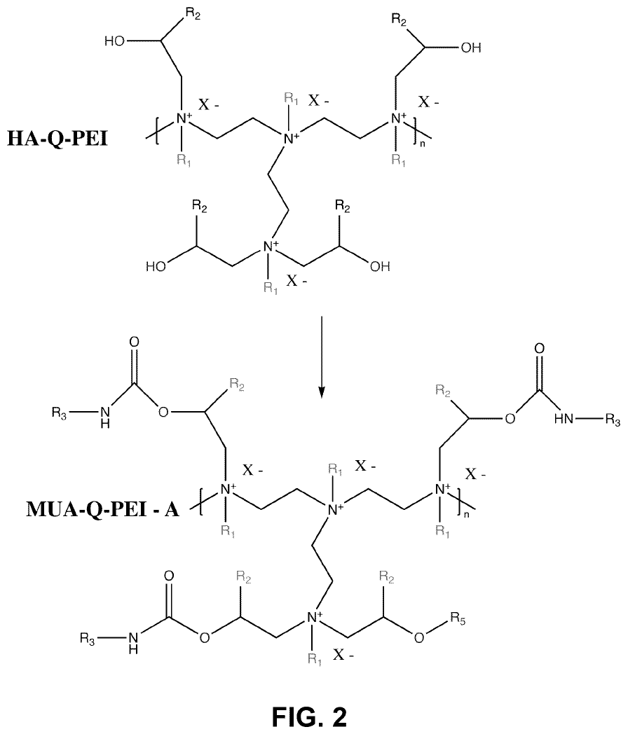

In a second step, the polymers above are reacted with one or a blend of hydrophobic monoisocyanates such that, in one case, less than 100% of the free hydroxyl groups are reacted to give the polymers in FIG. 2, referred to as Mono-Urethane-substituted Alkyl Quaternary PEI-A (MUA-Q-PEI-A).

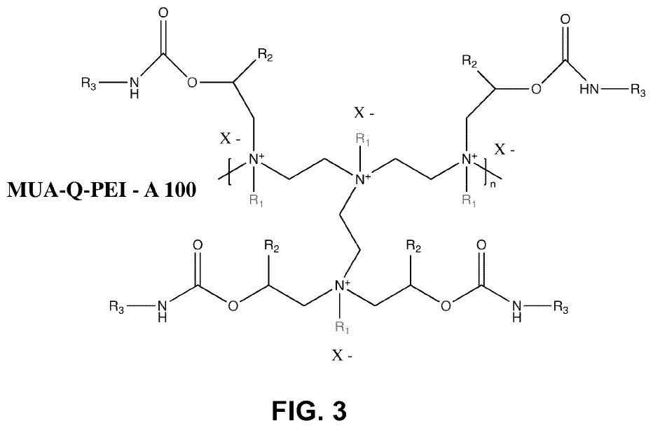

In alternative embodiments, 100% of the free hydroxyl groups are reacted to give the polymers in FIG. 3, referred to as Mono-Urethane substituted Alkyl Quaternary PEI-A100 (MUA-Q-PEI-A100). Both of these polymers (A and A100) are in general water insoluble and suitable in some embodiments for surface coatings.

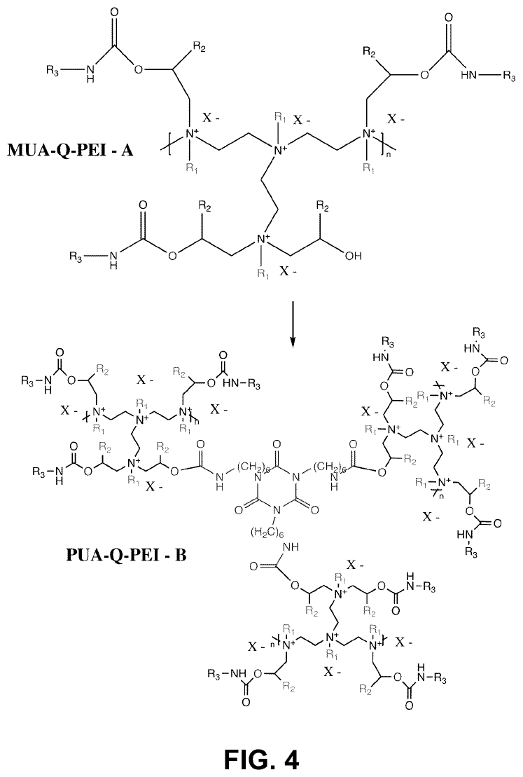

In other embodiments, to produce even more durable surface coatings, the polymers of the type MUA-Q-PEI-A are dissolved in a solvent along with a polyisocyanate and coated onto a surface whereby some of the remaining unreacted free hydroxyl groups react with the polyisocyanate to form a very durable cross-linked PolyUrethane Alkyl Quaternary PEI-B (PUA-Q-PEI-B) coating after drying (see FIG. 4).

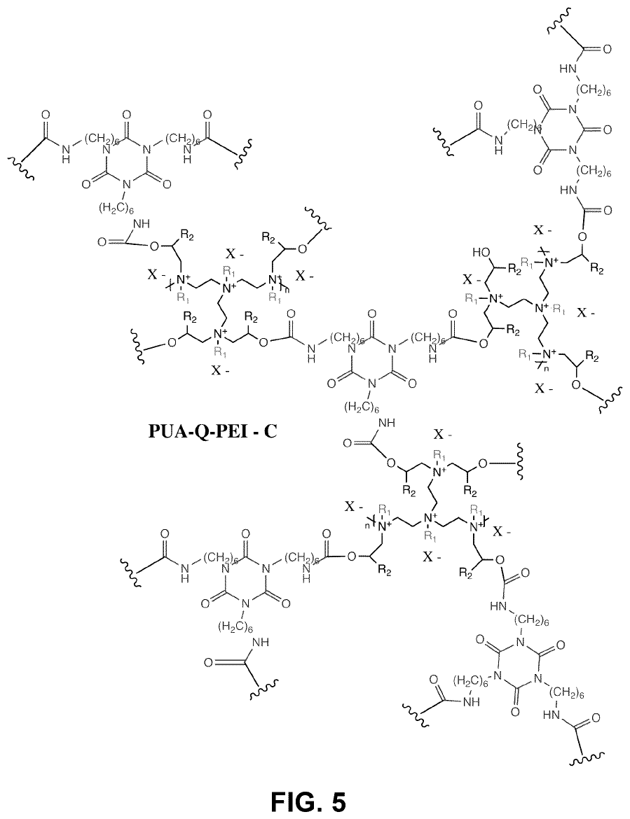

In yet other embodiments, a surface coating can be produced by applying a solution of a polymer of the HA-Q-PEI type along with a polyisocyanate to produce a cross-linked polymer PolyUrethane Alkyl Quaternary PEI-C (PUA-Q-PEI-C) as shown in FIG. 5.

The synthesis of these antimicrobial polymers is relatively simple using only commercially-available materials. It will be appreciated that this novel family of antimicrobial polymers and the general method to prepare them offers a great deal of versatility to adjust and fine tune physical and chemical properties and their antimicrobial properties for a range of different surfaces and applications. Examples of variables available for this fine-tuning include, but are not limited to, the molecular weight of the PEI, whether the PEI is linear, branched or hyperbranched, the ratio of primary, secondary and tertiary amines, the R group on the epoxide used, the alkylating agent used for PEI quaternization, the degree of quaternization, the monoisocyanate(s) used, the % of hydroxyl groups reacted with the monoisocyanate(s) (including 0%), the polyisocyanate used and the degree of cross-linking. It will also be appreciated that other means of cross-linking may be used besides using polyisocyanates.

Some embodiments of the technology described herein can be defined according to any of the following numbered paragraphs:
1. An antimicrobial composition comprising Mono-Urethane substituted Alkyl Quaternary Polyethyleneimine (PEI)-A (MUA-Q-PEI-A), wherein the MUA-Q-PEI-A is formed by reacting at least one monoisocyanate with Hydroxyl Alkyl Quaternary PEI (HA-Q-PEI).
2. The antimicrobial composition of paragraph 1, wherein 20% to 100% of the hydroxyl group of the HA-Q-PEI are converted to urethane group by reacting with at least one monoisocyanate.
3. The antimicrobial composition of paragraph 1, wherein 50% to 95% of the hydroxyl group of the HA-Q-PEI are converted to urethane group by reacting with at least one monoisocyanate.
4. The antimicrobial composition of any one of paragraphs 1-3, wherein the monoisocyanate is selected from the group comprising alkyl-, alkylaryl-, arylalkyl- and aryl-monoisocyanate.
5. The antimicrobial composition of any one of paragraphs 1-3, wherein the monoisocyanate is a blend of octylisocyanate and octadecylisocyanate.
6. The antimicrobial composition of paragraph 5, wherein the molar ratio of octylisocyanate to octadecylisocyanate is from 1/9 to 5/5.
7. The antimicrobial composition of paragraph 5, wherein the molar ratio of octylisocyanate to octadecylisocyanate is from 2/8 to 4/6.
8. The antimicrobial composition of any one of paragraphs 1-3, wherein the monoisocyanate is a fluoro- or organosilicone-substituted monoisocyanate.
9. The antimicrobial composition of any one of paragraphs 1-3, wherein the polyethyleneimine has an average molecular weight between 600 and 1,000,000.
10. The antimicrobial composition of any one of paragraphs 1-3, wherein the polyethyleneimine has an average molecular weight between 25,000 and 270,000.
11. The antimicrobial composition of any one of paragraphs 1-3, wherein the polyethyleneimine is a linear, branched, hyperbranched polyethyleneimine or their blend (i.e., a combination of two or more thereof).
12. The antimicrobial composition of any one of paragraphs 1-3, wherein the MUA-Q-PEI-A has a counterion selected from the group consisting of: halides, sulfate, sulfonate, phosphate, carbonate, and borate.
13. The antimicrobial composition of paragraph 12, wherein the counterion is chloride, bromide, iodide or sulfate.
14. The antimicrobial composition of paragraph 1, wherein the reactant HA-Q-PEI is formed by reacting Polyethyleneimine with a mono-epoxide and quaternizing with a quaternizing agent.
15. The antimicrobial composition of paragraph 14, wherein the mono-epoxide is an alkyl epoxide.
16. The antimicrobial composition of paragraph 15, wherein the alkyl epoxide is selected from the group consisting of: propyl epoxide, butyl epoxide, and hexyl epoxide.
17. The antimicrobial composition of paragraph 15, wherein the alkyl epoxide is propyl epoxide.
18. The antimicrobial composition of paragraph 14, wherein the quaternizing agent is an alkyl halide or arylalkyl halide.
19. The antimicrobial composition of paragraph 14, wherein the quaternizing agent is benzyl halide or hexyl halide.
20. An antimicrobial composition comprising cross-linked Polyurethane Alkyl Quaternary PEI-B (PUA-Q-PEI-B), wherein the PUA-Q-PEI-B is formed by crosslinking the MUA-Q-PEI of paragraph 1 with at least one polyisocyanate.
21. The antimicrobial composition of paragraph 20, wherein the polyisocyanate has an average isocyanate functionality of 2 to 5.
22. The antimicrobial composition of paragraph 20, wherein the polyisocyanate has an average isocyanate functionality of 3 to 4.
23. The antimicrobial composition of any one of paragraphs 20-22, wherein the polyisocyanate is prepared from diisocyanates selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).
24. The antimicrobial composition of any one of paragraphs 20-22, wherein the polyisocyanate is an isocyanate-end-capped oligomer prepared from a multifunctional isocyanate and a polyol.
25. The antimicrobial composition of paragraph 24, wherein the polyol is selected from the group consisting of: polyester polyol, polyether polyol, polysiloxane polyol, polycaprolactone polyol, and polybutadiene polyol.
26. An antimicrobial composition comprising a cross-linked Polyurethane Alkyl Quaternary PEI-C (PUA-Q-PEI-C), wherein the PUA-Q-PEI-C is formed by reacting at least one polyisocyanate with HA-Q-PEI.
27. The antimicrobial composition of paragraph 26, wherein the polyisocyanate has an average isocyanate functionality of 2 to 5.
28. The antimicrobial composition of paragraph 26, wherein the polyisocyanate has an average isocyanate functionality of 3 to 4.
29. The antimicrobial composition of any one of paragraphs 26-28, wherein the polyisocyanate is prepared from diisocyanates selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).
30. The antimicrobial composition of paragraph 29, wherein the polyisocyanate is an isocyanate- end-capped oligomer prepared from a multifunctional isocyanate and a polyol.
31. The antimicrobial composition of paragraph 29, wherein the polyol is selected from the group consisting of: polyester polyol, polyether polyol, polysiloxane polyol, polycaprolactone polyol, and polybutadiene polyol.
32. An antimicrobial coating, coating fluid or spraying fluid comprising the compositions of any one of paragraphs 1 to 31.
33. The antimicrobial coating, coating fluid or spraying fluid of paragraph 32, wherein the HA-Q-PEI, MUA-Q-PEI-A, PUA-Q-PEI-B or PUA-Q-PEI-C is water soluble, water dispersible, alcohol soluble or alcohol dispersible.
34. A device, equipment, apparatus or accessory comprising the coating, coating fluid or spraying fluid of paragraph 32.
35. The device, equipment, apparatus or accessory of paragraph 34, wherein the coating fluid or spraying fluid is water soluble, water dispersible, alcohol soluble or alcohol dispersible.
36. The device, equipment, apparatus or accessory of any one of paragraphs 34-35, wherein the device, equipment, apparatus or accessory is selected from the group consisting of: a filter, an air purifier, and a mask.
37. The device, equipment, apparatus or accessory of any one of paragraphs 34-35, wherein the device, equipment, apparatus or accessory is selected from the group consisting of: keyboard, keypad, mouse, remote controller, touch screen, phone, and display.
38. A personal care aid comprising the coating, coating fluid or spraying fluid of paragraph 32.
39. The personal care aid of paragraph 38, wherein the coating fluid or spraying fluid is water soluble, water dispersible, alcohol soluble or alcohol dispersible.

In another aspect, provided herein is a polymer comprising, consisting essentially of, or consisting of a reaction product of a polyethyleneimine oligomer, a multifunctional crosslinker, an alkylating agent, an optional monoisocyanate and an optional catalyst; wherein the polyethyleneimine oligomer comprises optionally substituted hydroxyethylene functionality that reacts with one of or both of the optional monoisocyanate or the multifunctional crosslinker; and nitrogen atoms present in the polyethyleneimine oligomer are at least partially quaternized by the alkylating agent.

The hydroxyethylene functionality on the polyethyleneimine oligomer may be installed by reaction of a polyethyleneimine with a mono-epoxide. Accordingly, secondary and/or primary amines on the polyethyleneimine are alkylated with the mono-epoxide to form the hydroethylene functionality.

The hydroxyethylene functionality may be optionally substituted with C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy. In some embodiments, the hydroxyethylene functionality is substituted with C₁-C₆ alkyl optionally substituted with C₆-C₁₀ aryl. In some embodiments, the hydroxyethylene functionality is substituted with C₁-C₆ alkyl optionally substituted with C₁-C₆ alkoxy, wherein the C₁-C₆ alkoxy is optionally substituted with hydroxy. In some embodiments, the hydroxyethylene functionality is substituted with C₁-C₆ alkyl optionally substituted with C₁-C₆ alkoxy, wherein the C₁-C₆ alkoxy is optionally substituted with C₁-C₆ alkoxy. In some embodiments, the hydroxyethylene functionality is substituted with C₁-C₆ alkyl optionally substituted with C₁-C₆ alkoxy, wherein the C₁-C₆ alkoxy is optionally substituted with C₆-C₁₀ aryl, wherein the C₆-C₁₀ aryl is optionally substituted with C₁-C₆ alkyl. In some embodiments, the hydroxyethylene functionality is substituted with C₁-C₆ alkyl optionally substituted with C₁-C₆ alkoxy, wherein the C₁-C₆ alkoxy is optionally substituted with carboxy. In some embodiments, the hydroxyethylene functionality is substituted with C₁-C₆ alkyl.

The polyethyleneimine oligomer may comprise, consist essentially of, or consist of a reaction product of a polyethyleneimine and a mono-epoxide, wherein the mono-epoxide is optionally substituted with C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy. In some embodiments, the mono-epoxide is substituted with C₁-C₆ alkyl optionally substituted with C₆-C₁₀ aryl. In some embodiments, the mono-epoxide is substituted with C₁-C₆ alkyl optionally substituted with C₁-C₆ alkoxy, wherein the C₁-C₆ alkoxy is optionally substituted with hydroxy. In some embodiments, the mono-epoxide is substituted with C₁-C₆ alkyl optionally substituted with C₁-C₆ alkoxy, wherein the C₁-C₆ alkoxy is optionally substituted with C₁-C₆ alkoxy. In some embodiments, the mono-epoxide is substituted with C₁-C₆ alkyl optionally substituted with C₁-C₆ alkoxy, wherein the C₁-C₆ alkoxy is optionally substituted with C₆-C₁₀ aryl, wherein the C₆-C₁₀ aryl is optionally substituted with C₁-C₆ alkyl. In some embodiments, the mono-epoxide is substituted with C₁-C₆ alkyl optionally substituted with C₁-C₆ alkoxy, wherein the C₁-C₆ alkoxy is optionally substituted with carboxy. In some embodiments, the mono-epoxide is a C₁-C₆ alkyl epoxide. In some embodiments, the C₁-C₆ alkyl epoxide is selected from the group consisting of propyl epoxide, butyl epoxide, and hexyl epoxide.

The polyethyleneimine may have a molecular weight of about 600 to about 270,000 daltons, or any range therebetween. This includes a molecular weight of 600, 800, 1000, 5000, 10000, 15000, 20000, 25000, 30000, 35000, 40000, 45000, 50000, 55000, 60000, 65000, 70000, 75000, 80000, 85000, 90000, 95000, 100000, 105000, 110000, 115000, 120000, 125000, 130000, 135000, 140000, 145000, 150000, 155000, 160000, 165000, 170000, 175000, 180000, 185000, 190000, 195000, 200000, 205000, 210000, 215000, 220000, 225000, 230000, 235000, 240000, 245000, 250000, 255000, 260000, 265000, or 270000 daltons, or any value therebetween. In some embodiments, the polyethyleneimine has a molecular weight of about 10,000 to about 200,000 daltons. In some embodiments, the polyethyleneimine has a molecular weight of about 25,000 to about 120,000 daltons. The polyethyleneimine may be branched or hyperbranched.

In some embodiments, the polyethyleneimine has a ratio of primary to secondary to tertiary amines of about 1:2:1 to about 1:1:1. In some embodiments, the polyethyleneimine has a ratio of primary to secondary to tertiary amines of about 1:1:0.7.

The multifunctional crosslinker may be a polyisocyanate. In some embodiments, the polyisocyanate has an average isocyanate functionality of 2 to 5. This includes an average isocyanate functionality of 2, 3, 4, or 5. In some embodiments, the polyisocyanate has an average isocyanate functionality of 3 or 4.

The polyisocyanate may be prepared from diisocyanates selected from the group consisting of: hexamethylene diisocyanate (HDI), isophorone diisocyanate (IPDI), toluene diisocyanate (TDI), methylene diphenyl diisocyanate (MDI), xylenediisocyanate (XDI), methylene-bis-(4-cyclohexylisocyanate) (H12MDI), meta-tetramethylxylene diisocyanate (TMXDI), and trimethylhexamethylene diisocyanate (TMDI).

In some embodiments, the polyisocyanate is selected from the group consisting of DESMODUR® N-3300, DESMODUR® N-100, DESMODUR® Z4470SN, WANNATE® T series polyisocyanates, and LUPRANATE® M series polyisocyanates. DESMODUR® N-3300 and DESMODUR® N-100 are aliphatic polyisocyanates based on HDI (hexamethylene diisocyanate) trimer. DESMODUR® Z4470SN is a multifunctional polyisocyanate based on IPDI (isophorone diisocyanate). WANNATEO T series polyisocyanates are toluene diisocyanate (TDI)-based aromatic polyisocyanates. LUPRANATE® M series polyisocyanates are 4,4-diphenylmethane diisocyanate (MDI)-based aromatic polyisocyanates.

At least 75% of the nitrogen atoms of the polyethyleneimine oligomer may be quaternized by the alkylating agent. This includes 75, 76, 77, 78, 79, 80, 81, 82, 83, 84, 85, 86, 87, 88, 89, 90, 91, 92, 93, 94, 95, 96, 97, 98, 99, or 100% of the nitrogen atoms of the polyethyleneimine oligomer being quaternized by the alkylating agent.

The alkylating agent may comprise, consist essentially of, or consist of one or more R₂-LG, wherein each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy; and each LG is a leaving group. As used herein, a “leaving group” refers to a halide (e.g., chloride, bromide, or iodide), a sulfonate (e.g., mesylate, tosylate, triflate, nonaflate), a fluorosulfate, or an acetate. In some embodiments, each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy. In some embodiments, the alkylating agent is benzyl halide or hexyl halide. In some embodiments, the alkylating agent is hexyl halide. In some embodiments, the alkylating agent is benzyl halide.

The monoisocyanate may comprise, consist essentially of, or consist of one or more R₃—NCO, wherein each R₃ is independently selected from (1) C₆-C₂₀ alkyl optionally substituted with 1-3 substituents independently selected from halogen, —SiRₐ(OR_{b})(OR_{c}), and C₆-C₁₀ aryl; and (2) C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and -Si(C₁-C₆ alkyl)₃. In some embodiments, the monoisocyanate comprises one or more R₃—NCO, wherein each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments, the monoisocyanate comprises one or more R₃-NCO, wherein each R₃ is independently selected from C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and —Si(C₁-C₆ alkyl)₃. In some embodiments, the monoisocyanate comprises octylisocyanate, octadecylisocyanate, or a combination thereof.

In some embodiments, at least 20% of the optionally substituted hydroxyethylene functionality reacts with the monoisocyanate and no more than 25% of the optionally substituted hydroxyethylene functionality reacts with the polyisocyanate. This includes 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% or more, but less than 100%, of the optionally substituted hydroxyethylene functionality reacting with the monoisocyanate. In some embodiments, at least 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% or more, but less than 100%, of the optionally substituted hydroxyethylene functionality reacts with the monoisocyanate. In some embodiments, 25, 24, 23, 22, 21, 20, 19, 18, 17, 16, 15, 14, 13, 12, 11, 10, 9, 8, 7, 6, 5, 4, 3, 2, or 1% or less, but more than 0%, of the optionally substituted hydroxyethylene functionality reacts with the polyisocyanate. In some embodiments, no more than 25, 24, 23, 22, 21, 20, 19, 18, 17, 16, 15, 14, 13, 12, 11, 10, 9, 8, 7, 6, 5, 4, 3, 2, or 1% or less, but more than 0%, of the optionally substituted hydroxyethylene functionality reacts with the polyisocyanate.

In some embodiments, 100% of the optionally substituted hydroxyethylene functionality reacts with the polyisocyanate.

In some embodiments, the polymer comprises, consists essentially of, or consists of a reaction product of a polyethyleneimine oligomer, a polyisocyanate, an alkylating agent, and optionally a catalyst, in the absence of monoisocyanate.

The catalyst may comprise, consist essentially of, or consist of dibutyl tin dilaurate or bismuth carboxylate. In some embodiments, the catalyst comprises, consists essentially of, or consists of dibutyl tin dilaurate. In some embodiments, the catalyst comprises, consists essentially of, or consists of bismuth carboxylate.

In another aspect, provided herein is a polymer that is compound (IV):

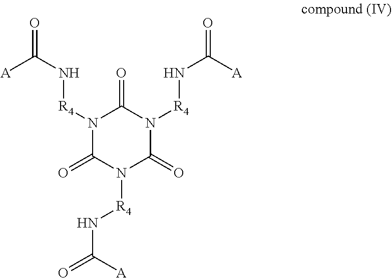

wherein:

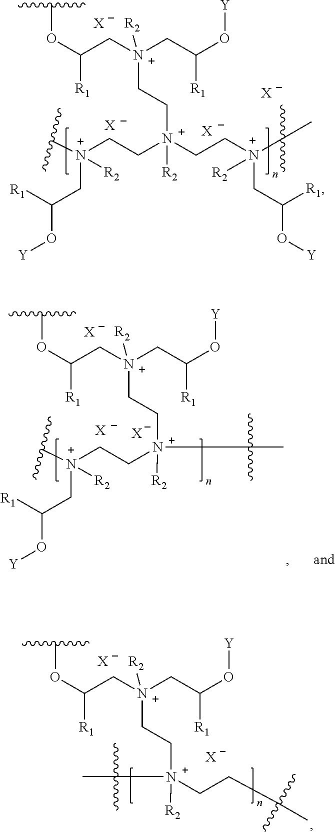

each A is independently selected from
   or a copolymer of any two or more thereof; and attachment of each A forms a carbamate linkage;
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; (2) C₆-C₁₀ aryl optionally substituted with 1-3 substituents independently selected from halogen, C₁-C₆ alkyl, and —SiRₐ(OR_{b})(OR_{c}); and (3)

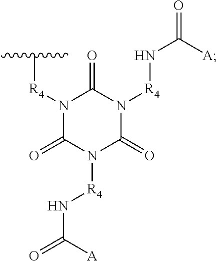

wherein each Rₐ is independently C₁-C₆ alkyl; and each R_{b} and each R_{c} are independently selected from C₁-C₆ alkyl and —Si(C₁-C₆ alkyl)₃;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In another aspect, provided herein is a polymer that is compound (V):

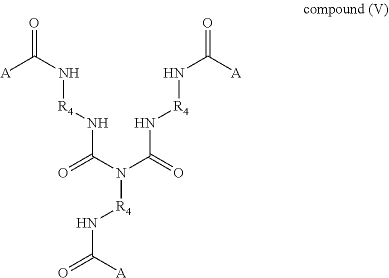

wherein:
each A is independently selected from

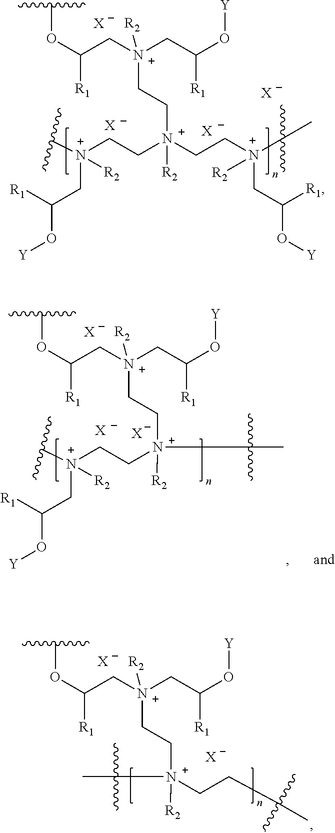

or a copolymer of any two or more thereof; and attachment of each A forms a carbamate linkage;
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; (2) C₆-C₁₀ aryl optionally substituted with 1-3 substituents independently selected from halogen, C₁-C₆ alkyl, and —SiRₐ(OR_{b})(OR_{c}); and (3)

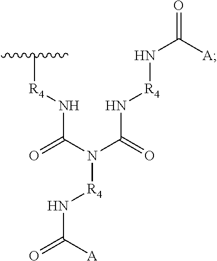

wherein each R ₐ is independently C₁-C₆ alkyl; and each R_{b} and each R_{c} are independently selected from C₁-C₆ alkyl and —Si(C₁-C₆ alkyl)₃;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In some embodiments of compound (IV) or compound (V), at least 75% but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₆-C₁₀ alkyl)₃. This includes 75, 76, 77, 78, 79, 80, 81, 82, 83, 84, 85, 86, 87, 88, 89, 90, 91, 92, 93, 94, 95, 96, 97, 98, or 99% or more, but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆ alkyl)₃.

In some embodiments of compound (IV) or compound (V), each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments of compound (IV) or compound (V), each R₃ is independently selected from C₆-C₂₀ alkyl. In some embodiments of compound (IV) or compound (V), R₃ is octyl, octadecyl, or a combination thereof. In some embodiments of compound (IV) or compound (V), R₃ is independently selected from C₆-C₁₀ aryl optionally substituted with 1-3 substituents independently selected from halogen, C₁-C₆ alkyl, and —SiRa(ORb)(ORO.

In some embodiments of compound (IV), R₃ is

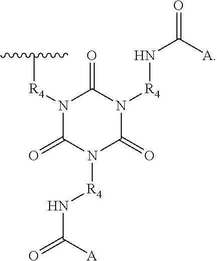

In some embodiments of compound (V), R₃ is

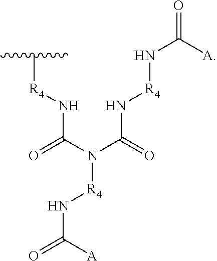

In some embodiments of compound (IV) or compound (V), each R₁ is independently C₁-C₆ alkyl.

In some embodiments of compound (IV) or compound (V), each R₂ is independently selected from C₁-C₆ alkyl optionally substituted with a substituent selected from hydroxy, C₁-C₆ alkoxy, carboxy, C₆-C₁₀ aryl, —O(O)O(C₁-C₆ alkyl), —C(O)—(C₆-C₁₀ aryl), and C₁-C₆ alkoxy optionally substituted with hydroxy. In some embodiments of compound (IV) or compound (V), each R₂ is independently selected from C₁-C₆ alkyl optionally substituted with hydroxy. In some embodiments of compound (IV) or compound (V), each R₂ is independently selected from C₁-C₆ alkyl optionally substituted with C₁-C₆ alkoxy. In some embodiments of compound (IV) or compound (V), each R₂ is independently selected from C₁-C₆ alkyl optionally substituted with carboxy. In some embodiments of compound (IV) or compound (V), each R₂ is independently selected from C₁-C₆ alkyl optionally substituted with C₆-C₁₀ aryl. In some embodiments of compound (IV) or compound (V), each R₂ is independently selected from C₁-C₆ alkyl optionally substituted with C₁-C₆ alkoxy, wherein the C₁-C₆ alkoxy is optionally substituted with hydroxy. In some embodiments of compound (IV) or compound (V), each R₂ is independently selected from C₁-C₆ alkyl optionally substituted with —C(O)O(C₁-C₆ alkyl) or —C(O)—(C₆-C₁₀ aryl). In some embodiments of compound (IV) or compound (V), each R₂ is independently selected from methyl, butyl, hexyl, benzyl, —CH₂C(O)Ph, and —CH₂C(O)OCH₂CH₃. In some embodiments of compound (IV) or compound (V), R₂ is hexyl or benzyl. In some embodiments of compound (IV) or compound (V), R₂ is hexyl. In some embodiments of compound (IV) or compound (V), R₂ is benzyl.

In some embodiments of compound (IV) or compound (V), R₄ is C₁-C₁₀ alkylene optionally substituted with phenyl. In some embodiments of compound (IV) or compound (V), R₄ is alkylene. In some embodiments of compound (IV) or compound (V), R₄ is a 3- to 8-member cycloalkyl ring.

In another aspect, provided herein is a polymer comprising, consisting essentially of, or consisting of compound (VI), compound (VII), or compound (VIII):

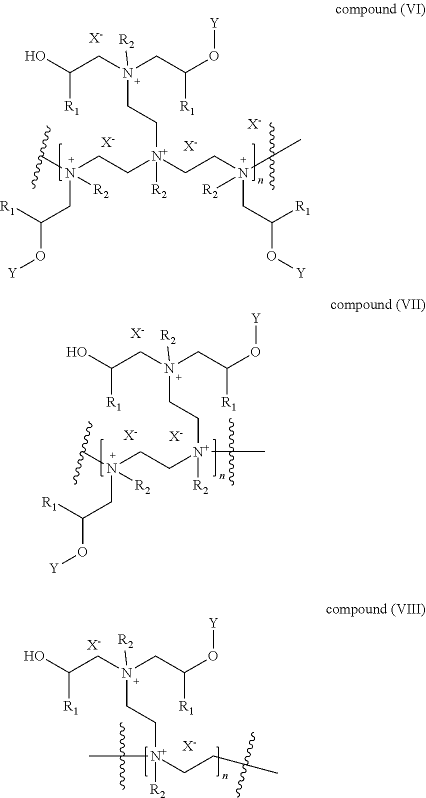

or a combination of any two or more thereof, or a copolymer of any two or more thereof, wherein:
each Y is independently H or —C(O)—NHR₃;
each n is an integer independently selected from 1 to 3000, preferably an integer independently selected from 100 to 1000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; and (2) C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

In some embodiments of compound (VI), compound (VII), or compound (VIII), each R₁ is independently C₁-C₆ alkyl.

In some embodiments of compound (VI), compound (VII), or compound (VIII), each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy. In some embodiments of compound (VI), compound (VII), or compound (VIII), each R₂ is independently selected from C₁-C₆ alkyl optionally substituted with hydroxy. In some embodiments of compound (VI), compound (VII), or compound (VIII), each R₂ is independently selected from C₁-C₆ alkyl optionally substituted with C₁-C₆ alkoxy. In some embodiments of compound (VI), compound (VII), or compound (VIII), each R₂ is independently selected from C₁-C₆ alkyl optionally substituted with carboxy. In some embodiments of compound (VI), compound (VII), or compound (VIII), each R₂ is independently selected from C₁-C₆ alkyl optionally substituted with C₆-C₁₀ aryl. In some embodiments of compound (VI), compound (VII), or compound (VIII), each R₂ is independently selected from C₁-C₆ alkyl optionally substituted with —C(O)O(C₁-C₆ alkyl) or —C(O)—(C₆-C₁₀ aryl). In some embodiments of compound (VI), compound (VII), or compound (VIII), each R₂ is independently selected from C₁-C₆ alkyl optionally substituted with C₁-C₆ alkoxy, wherein the C₁-C₆ alkoxy is optionally substituted with hydroxy. In some embodiments of compound (VI), compound (VII), or compound (VIII), each R₂ is independently selected from methyl, butyl, hexyl, benzyl, —CH₂C(O)Ph, and —CH₂C(O)OCH₂CH₃. In some embodiments of compound (VI), compound (VII), or compound (VIII), R₂ is hexyl or benzyl. In some embodiments of compound (VI), compound (VII), or compound (VIII), R₂ is hexyl. In some embodiments of compound (VI), compound (VII), or compound (VIII), R₂ is benzyl.

In some embodiments of compound (VI), compound (VII), or compound (VIII), each R₃ is independently selected from C₆-C₂₀ alkyl optionally substituted with 1-3 substituents independently selected from halogen, —SiRₐ(OR_{b})(OR_{c}), and C₆-C₁₀ aryl. In some embodiments of compound (VI), compound (VII), or compound (VIII), each R₃ is independently selected from C₆-C₂₀ alkyl. In some embodiments of compound (VI), compound (VII), or compound (VIII), R₃ is octyl, octadecyl, or a combination thereof. In some embodiments of compound (VI), compound (VII), or compound (VIII), R₃ is independently selected from C₆-C₁₀ aryl optionally substituted with 1-3 substituents independently selected from halogen, C₁-C₆ alkyl, and —SiRₐ(OR_{b})(OR_{c}).

In some embodiments of compound (VI), compound (VII), or compound (VIII), at least 75% but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆ alkyl)₃. This includes 75, 76, 77, 78, 79, 80, 81, 82, 83, 84, 85, 86, 87, 88, 89, 90, 91, 92, 93, 94, 95, 96, 97, 98, or 99% or more, but not all of the R₃ are independently selected from C₆-C₂₀ alkyl optionally substituted with 1-3 substituents independently selected from halogen, —SiRₐ(OR_{b})(OR_{c}), and C₆-C₁₀ aryl; and C₆-C₁₀ aryl optionally substituted with 1-3 substituents independently selected from halogen, C₁-C₆ alkyl, and —SiRₐ(OR_{b})(OR_{c}); and wherein each Rₐ is independently C₁-C₆ alkyl; and each R_{b} and each R_{c} are independently selected from C₁-C₆ alkyl and —Si(C₁-C₆ alkyl)₃.

For compound (IV), compound (V), compound (VI), compound (VII), or compound (VIII), each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives. As used herein, and unless stated otherwise, “organo-substituted derivatives” refers to anions wherein a sulfur atom, a phosphorous atom, a boron atom, a silicon atom or carbonyl group is substituted with either an alkyl or an aryl group. Non-limiting examples include methylsulfate, methanesulfonate, p-toluene sulfonate, trifluoromethylsulfonate, and trifluoroacetate.

In another aspect, provided herein is an antimicrobial composition comprising, consisting essentially of, or consisting of a polymer disclosed herein. In some embodiments, the polymer comprises, consists essentially of, or consists of compound (IV). In some embodiments, the polymer comprises, consists essentially of, or consists of compound (V). In some embodiments, the polymer comprises, consists essentially of, or consists of compound (VI), compound (VII), or compound (VIII), or a combination of any two or more thereof, or a copolymer of any two or more thereof.

In another aspect, provided herein is an antimicrobial coating, coating fluid, or spraying fluid comprising, consisting essentially of, or consisting of an antimicrobial composition described herein. In some embodiments, the coating fluid or spraying fluid is water soluble, water dispersible, alcohol soluble, or alcohol dispersible. In some embodiments, the coating fluid or spraying fluid is water soluble or water dispersible. In some embodiments, the coating fluid or spraying fluid is alcohol soluble or alcohol dispersible.

In another aspect, provided herein is a device, equipment, apparatus, or accessory comprising the antimicrobial coating, coating fluid, or spraying fluid described herein. Non-limiting examples of the device, equipment, apparatus, or accessory include a filter, an air purifier, mask, or other personal protection device (PPD), respirator, etc. Other non-limiting examples include a keyboard, a keypad, a mouse, a remote controller, a touch screen, a phone, and a display or any device integrating any of the foregoing components.

In another aspect, provided herein is a personal care aid comprising the coating, coating fluid, or spraying fluid described herein. Non-limiting examples of a personal care aid include facial tissue, hand soap, and a cleansing pad.

### Methods of Use

In another aspect, provided herein is a method to sanitize a surface, the method comprising, consisting essentially of, or consisting of applying a composition disclosed herein to the surface.

In another aspect, provided herein is a method to reduce (e.g., minimize) antimicrobial growth on a surface, the method comprising, consisting essentially of, or consisting of applying a composition disclosed herein to the surface. In some embodiments, the method includes forming a coating solution containing a composition according to any of the embodiments set forth herein. The method further includes directing, via an applicator (e.g., a sprayer), the coating solution to a surface, and providing a coating on the surface through the application of the coating solution to the surface.

In another aspect, provided herein is a method to prevent antimicrobial growth on a surface, the method comprising, consisting essentially of, or consisting of applying a composition disclosed herein to the surface.

In some embodiments of the methods described above, the applying step comprises, consists essentially of, or consists of spraying or brushing the surface with the composition. In some embodiments of the methods described above, the applying step comprises, consists essentially of, or consists of dipping the surface into a coating solution containing a composition according to any of the embodiments set forth herein. In some embodiments of the methods described above, the applying step comprises, consists essentially of, or consists of applying the composition to the surface by an electrostatic process.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. Moreover, due to biological functional equivalency considerations, some changes can be made in protein structure without affecting the biological or chemical action in kind or amount. These and other changes can be made to the disclosure in light of the detailed description. All such modifications are intended to be included within the scope of the appended claims.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

The technology described herein is further illustrated by the following examples which in no way should be construed as being further limiting. Although methods and materials similar or equivalent to those described herein can be used in the practice or testing of this disclosure, suitable methods and materials are described below.

### EXAMPLES

The present technology now being generally described, it will be more readily understood by reference to the following examples, the first three of which describe the general synthetic procedures for synthesizing HA-Q-PEI polymers, for reacting them with monoisocyanates to produce MUA-Q-PEI-A polymers and for preparing cross-linked MUA-Q-PEI-B polymer coatings. These are included merely for purposes of illustration of certain aspects and embodiments of the present technology and are not intended to limit the present technology.

### Example 1 Synthesis of a Hydroxypropyl Quaternary Ammonium PEI

For the purposes of the chemistry described herein, the ratio of primary, secondary and tertiary amines in branched PEI is assumed to be 1:2:1 as has been reported in the literature. 24,25

The procedure used is essentially as described in Gao et al. (2007). 26 The structure for the polymer Compound (I), as shown below, is intended to be an approximation indicating that most of the primary and secondary amines have been reacted with the epoxide with most of the tertiary amines quaternized by alkylation with the benzyl chloride.

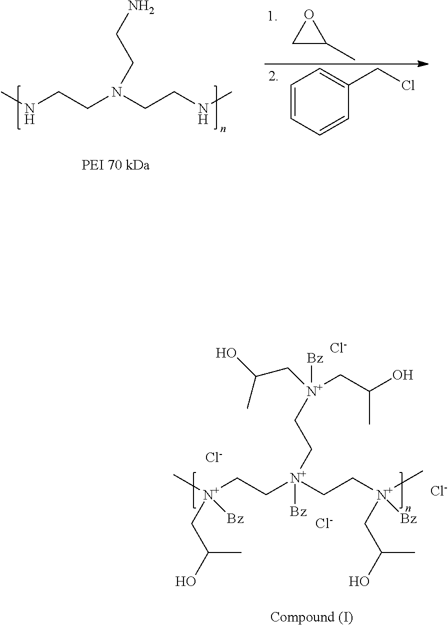

To a 25 mL two-neck flask under nitrogen was added 3.33 g of 70 kDa PEI solution (30% in water/1g PEI, assume mw=43.1 g/mol, 23.2 mmol) and was cooled to 0° C. To this mixture, 5.4 g (92.8 mmol) propylene oxide was added dropwise at 0-3° C. After the addition was completed, the reaction mixture was stirred at 0-3° C. for seven hours. Then the temperature of the reaction mixture was increased to 35° C. and the unreacted propylene oxide was distilled out (−3.60 mL). Added to the resulting solution was 11.75 g (10.6 mL, 92.8 mmol) of benzylchloride and the reaction was heated to 50° C. for 30 hours. The reaction was extracted with diethyl ether (3×20 mL) to remove unreacted benzylchloride, residual propylene oxide, and oleophilic side products or impurities, if there are any. The water phase was separated and vaporized under vacuum and dried by lyophilization leaving the Compound (I) as a transparent solid (2.85 g). The product was characterized by proton NMR and Infrared (IR) spectroscopy.

### Example 2 Process for Reaction of Hydroxypropyl Quaternary Ammonium PEI with Monoisocyanates (Approximately 85% Of Free OH Groups)

The structure for the polymer product, as shown below, is intended to be an approximation indicating that most of the hydroxyl groups (−85% molar equivalent) have been reacted with the blend of monoisocyanates to form urethanes with some hydroxyl groups remaining unreacted.

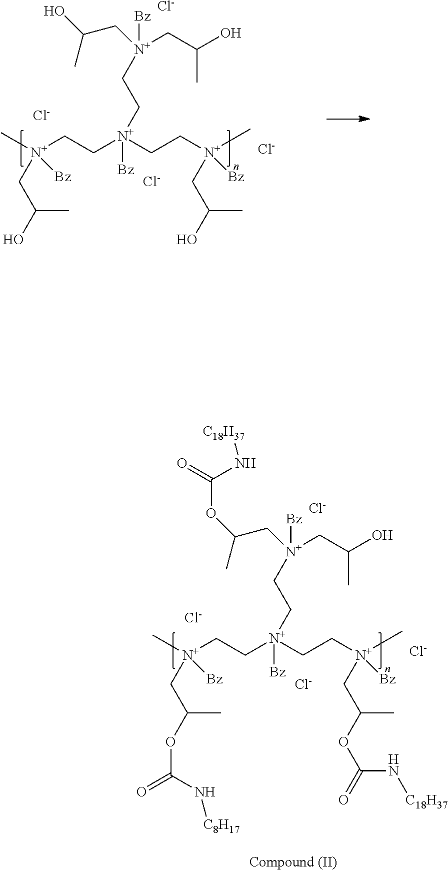

The concentration of reactive hydroxyl groups (mmol/gram of dry polymer) was determined by titrating a known amount (grams) of the dried HA-Q-PEI polymer with a known excess amount (grams, mmoles) of Octasdecylisocyanate. The percentage of monoisocyanate which was consumed in the reaction was determined by monitoring the reaction progress using infrared (IR) spectroscopy to monitor the drop in the isocyanate peak at 2263 cm⁻¹. From the percentage drop in this peak, the number of mmoles of isocyanate consumed was estimated. This value was equivalent to the number of mmoles of polymer hydroxyl groups which reacted with the isocyanate. In this way, a hydroxyl group concentration of the polymer (mmoles reactive hydroxyl groups/g dry polymer) was calculated and then used in subsequent reactions to determine the amount of monoisocyanate(s) required to functionalize specific percentages of the reactive hydroxyl groups in the polymer and by doing so, would fine-tune the hydrophilic/hydrophobic properties of the polymer.

Using the procedure described in Example 1, 2.0 g (2.27 mmol assuming a molecular weight of 881 g/mole for the polymer unit cell) of the Hydroxypropyl Quaternary Ammonium PEI Compound (I) was prepared and then dried under vacuum at 60° C. for two hours followed by storing overnight in a desiccator at room temperature. To the dried polymer was added 13.8 g t-Butyl Alcohol and 9.2 g of Dimethyl Acetamide. The resulting mixture was stirred under nitrogen until the polymer completely dissolved. Both of these solvents were dried thoroughly with molecular sieve 4 Å before use. A mixture of 1.6 g (5.41 mmol) of octadecylisocyanate and 0.36 g (2.32 mmol) of octylisocyanate was added dropwise to the polymer solution. This mixture totaled 7.73 mmol of monoisocyanate which corresponds to approximately 85% of the available hydroxyl groups. The reaction mixture turned slightly cloudy. The resulting reaction mixture was stirred at room temperature under nitrogen for twelve hours. The resulting reaction mixture was filtered with a PTFE filter (1 μ) affording the 20.83 grams of the Compound (II) as a 12.19% solid solution. IR spectroscopy showed the expected new peak corresponding to the urethane carbonyls and no residual isocyanate peak.

In some embodiments, after the reaction with monoisocyanate(s) is complete, the reaction mixture was added to water to precipitate the MUA-Q-PEI-A product. This product was isolated and washed with water to remove any water soluble impurities and then dried for use in subsequent steps. This water precipitation step was useful for removing any water soluble impurities that may contribute to toxicity.

### Example 3 Process for Crosslinking and Coating Reaction of Octadecyl/Octyl Urethane Quaternary Ammonium PEI

The structure for the polymer Compound (III), as shown below, is intended to be an approximation indicating that some of the unreacted hydroxyl groups in Compound (II) have been reacted with the polyisocyanate to form urethane cross-links.

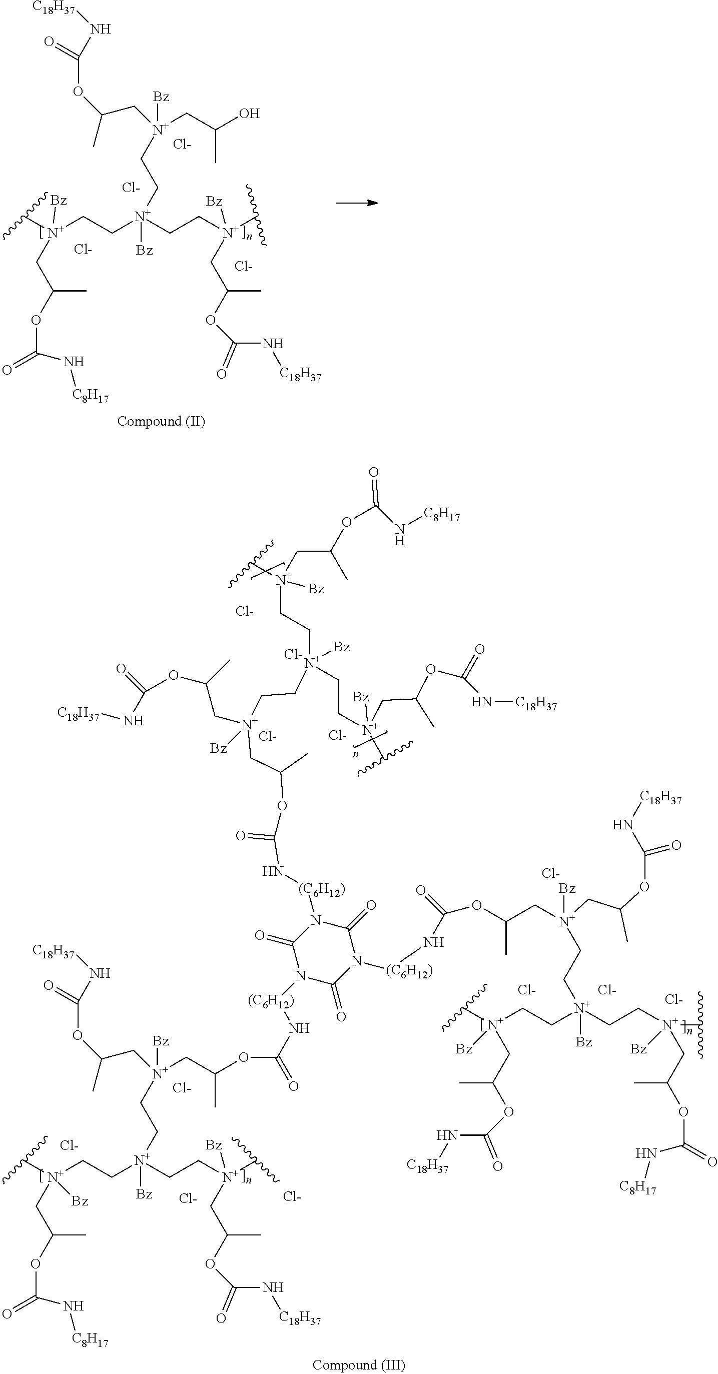

Using the procedure described in Example 2, 20 g of the Octadecyl/Octyl Urethane Quaternary Ammonium PEI was prepared, to which was added 1.25 g of Desmodur N3300 (50% solution in anhydrous acetone) and 0.18 g of a Dibutyltin Dilaurate 1% solution in dry toluene. The resulting mixture was mixed thoroughly and immediately coated, with a #36 Myer rod, onto a corona-pretreated white PET (2 mils, Milenex 339) supported with a stainless steel plate. The coated film was heated in an oven for 30 minutes at 60° C. without vacuum. This dried film was used for measurements of antimicrobial activity. IR spectroscopic analysis indicated no residual isocyanates.

It should be noted that the above crosslinking procedure has also been carried out without the Dibutyltin Dilaurate catalyst and afforded a reasonable coating albeit the resulting dried film was somewhat less durable than when the catalyst was used.

It will also be appreciated that several variations including, but not limited to those described below, can be used in the above-described process to adjust the physical, chemical and mechanical properties of the polymers, as needed, for a range of possible applications:
Different average molecular weight PEI's and PEI's with different degrees of branching.
Different epoxides other than propyl epoxide.
Different quaternizing groups other than benzyl.
The degree of hydroxyalkylation and of quaternization can be varied.
The degree of oligomer formation in the hydroalkylation reaction with alkyl epoxide.
Different monoisocyanates can be used and these can be single monoisocyanates or blends of monoisocyanates.
The reactions with monoisocyanates to form urethanes can be varied such that less than 100% of the hydroxyl groups are reacted or 100% of the hydroxyl groups are reacted.
Polyisocyanates other than N3300 can be used for crosslinking.
Different solvents may be used for the chemical reactions depending on the solubility of the PEI-derived polymers, which can be affected by the above-mentioned variations.
Reactants other than monoisocyanates and polyisocyanates can be used for reactions with the hydroxyl groups and for crosslinking.

### Example 4 Assessment of the Antiviral Activity of the Polymers and/or Coatings Thereof

The present study was conducted to assess the antiviral activity of the polymer coatings of the present technology. All samples and all accessories in the assessment were first disinfected by either high temperature autoclave treatment, alcohol cleaning or irradiation in a UV laminar flow chamber.

First, adenovirus (108 PFU/mL, plaque forming unit, MOI=100 multiplicity of infection) was diluted to 2×10⁷ PFU/ml in a phosphate buffer solution (PBS). Then, 0.1 mL of the diluted virus solution was deposited on the disinfected samples.

The antiviral activity was determined by two different methods: (i) the human cell (HuH7) method; and (ii) the quantitative reverse transcription polymerase chain reaction (RT-qPCR) method.

(i) Human cell (HuH7) Method

HuH7 is a type of human liver cell line that may be grown in the laboratory for research purposes. According to the web site huh7.com, it is “a well differentiated hepatocyte-derived carcinoma cell line, originally taken from a liver tumor in a 57-year-old Japanese male in 1982”.

For the assessment of antiviral activity, 0.1 mL of the virus (Adenovirus) in Dulbecco's Modified Eagle Medium (DMEM) +10% fetal bovine serum (FBS) medium was dropped onto the coating and also onto a control substrate and allowed to sit on the coating for 30 minutes. The virus/medium mixture was transferred to a Petri dish containing HuH7 cells (human liver cells) in the medium. The residual virus on the coating was rinsed twice with 0.1 mL of the medium and the liquid combined with the virus fluid in the Petri dish. The Petri dish was transferred to a CO₂ incubator and incubated at 37° C. with a relative humidity of about 95% and a CO₂ concentration of about 5% for 48 hours to amplify the signal.

Once the incubation was completed, visible light and fluorescence micrographs were taken of the virus/cell samples to determine the population of virus and the live/dead cells. For positive control, 0.1 mL of virus in the medium was transferred directly into the petri dish containing HuH7 cells in the medium.

### (ii) RT-qPCR Method

RT-qPCR is used in a variety of applications including pathogen detection, gene expression analysis, RNAi validation, microarray validation, genetic testing, and disease research.

### Sample Preparation

The medium (DMEM, high sucrose, pyruvate; ThermoFisher, Catalog number: 11995040) was removed from the refrigerator and conditioned in a water bath at 37° C. for 30 min.

Preparation of Virus Fluid: The typical virus count of the stock is 5 Lambda (5×10⁸) per tube. To the virus tube, 1 mL of DMEM medium was added and the tube was mixed homogeneously with a vortex mixer for 5-10 sec to make a virus fluid of 5×10⁸/mL concentration. The virus fluid was further diluted to 5×10⁷/mL with DMEM medium for the antivirus tests.

RT-qPCR Procedure for Coatings: The coated film was immersed in 99% alcohol for 1 sec. Any excess alcohol was removed from the surface. The film was then air-dried in a new petri dish for 15-20 min. Then 100 μL of the diluted virus fluid (5×10^{6 /}mL) was dropped onto the dried film. The petri dish was covered, and the virus allowed to contact the film for desired contact time period. In some of the experiments, the contact time was reduced to as short as 30 sec. The virus fluid from the film was transferred to an Eppendorf tube. The film was then rinsed twice with 50 μL of 1X PBD and the rinsing fluid was combined into the Eppendorf tube. The total test fluid volume was 200 μL and ready for the DNA extraction.

RT-qPCR Procedure for Aqueous Solutions: 100 μL of the test sample was added to 100 μL of the diluted virus fluid (5×10⁷/mL) in an Eppendorf tube and the mixture (5×10⁶ virus count) was shaken on a shaker for 30 min. DNA was extracted using the Novogene DNA kit following the specified extraction procedure.

RT-qPCR Tests: Each sample was tested in quadruplicates. The ingredients listed in Table 1 were mixed thoroughly in an Eppendorf tube.

TABLE 1
Formulation of the premix for q-RT-PCR Test

| Items | Volume (μL) |
|---|---|
| DI Water | 15.4 |
| Forward-primer | 2.2 |
| Reverse-primer | 2.2 |
| Master mix buffer (Kapa BioSystems PCR reagent) | 22.0 |
| Sample DNA | 4.4 (Added as the |
| | last ingredient) |
| TOTAL VOLUME | 46.2 μL |

### EGFP Primer Sequence:

| | | | | |
|---|---|---|---|---|
| Forward-primer | FLenti- | 5′AACCACTACCTgAgCACCCA3′(20) SEQ ID NO: 1 | 2 | OPC |
| | GFP | | | |
| Reverse-primer | RLenti- | 5′gTCCATgCCgAgAgTgATCC3′(20) SEQ ID NO: 2 | 2 | OPC |
| | GFP | | | |

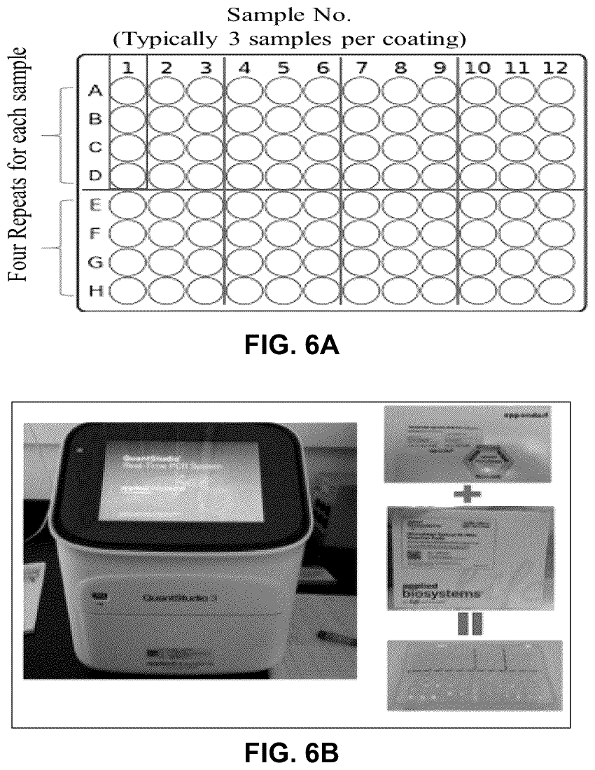

As illustrated in FIG. 6A, 10 μL of the premix was added to each cavity of the test plate, with three samples taken for each coating and each sample was done in quadruplicate. Accordingly, a total of 12 tests were done for each coating.

The plate was centrifuged to assure all the premix fluid flowed to the bottom of the cavities. As illustrated in FIG. 6B, the plate was then inserted into an Applied Biosystems QuantStudio 3 (ThermoFisher) to determine the Cycle Threshold (CT) number for the calculation of the antiviral efficiency. A quantitative RT-PCR method may be performed. The antiviral efficiency is calculated quantitatively from the CT number. For use of the QuantStudio 3 PCR procedure, see https://www.youtube.com/watch?v=udy7iskkZwE and https://www.youtube.com/watch?v=PjgwDhN63Zc.

### Testing

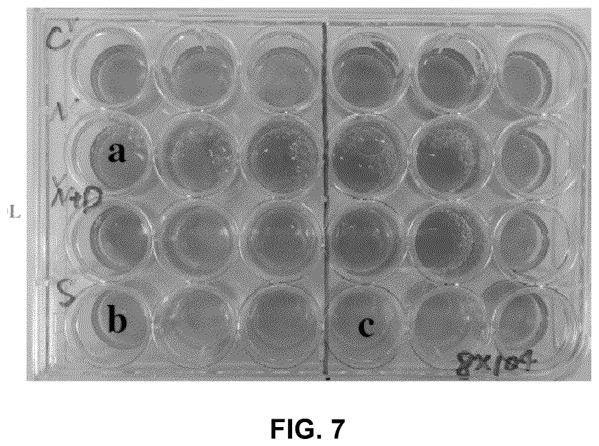

Qualitative Cell Viability Test for Coatings: The coating was placed in a petri dish and 100 μL of DMEM medium was dropped on the coating. The petri dish was then covered for 30 min. The medium on the film was then transferred to a cell plate containing 8×10⁴ cells in 500 μL of medium in each partition as shown in FIG. 7. The film was rinsed twice with 50 μL of DMEM medium and the rising fluid was combined with previous test fluid in the same location in the plate. A total of 200 μL of the test fluid was added to the 500 μL cell/medium. The cell plate was incubated at a 37° C./95% RH CO₂ incubator for 48-96 hours, after which the cell growth and morphology were observed under visible microscope. Dead cells floated or were suspended in the medium, while live cells remained fixed to the bottom of the plate. This test was for the assessment of the contact cytotoxicity of the polymer film. In cases where this test indicates some degree of cytotoxicity, the actual mechanism for the cell death is not given although cell death due to chemicals extracting from the coating are one possibility.

Qualitative Cell Viability Test for Polymer Solution or Dispersion: 100 μL of the polymer solution or dispersion and 100 μL of DMEM medium were added to an Eppendorf and mixed thoroughly with a shaker for 30 min. For polymer film, a fixed area of the film was cut and dispersed in the medium for the test. The test fluid was transferred to the cell plate and the cells were grown in a 37° C./95% RH CO₂ incubator for 48-96 hours. The cell growth and morphology were recorded under visible microscope.

Qualitative Antiviral Efficiency Test of Polymer film: 100 μL of the virus fluid (5×10⁷/mL) was dropped on the polymer film in a petri dish. The petri dish was covered for 30 min. The virus fluid was transferred to a cell plate containing 8×10⁴ cells in 500 μL of medium in each partition (see FIG. 7). The film was then rinsed twice with 50 μL of DMEM medium and the rising fluid was combined with previous test fluid in the same location in the plate. The total volume of the test fluid was 200 μL. The cell plate was then incubated at a 37° C./95% RH CO₂ incubator for 48-96 hours. Finally, the cell morphology and the fluorescence were recorded under UV microscope.

Qualitative Antiviral Efficiency Test of Polymer Solution or Dispersion: 100 μL of the virus fluid (5×10⁷/mL) and 100 μL of the polymer solution or dispersion were added to an Eppendorf and shaken thoroughly with a shaker for 30 min. The test mixture was added in a cell plate containing 8×10⁴ cells in 500 μL of medium in each partition. The cell plate was then incubated at a 37° C./95% RH CO₂ incubator for 48-96 hours. Finally, the cell morphology and the fluorescence were recorded under UV microscope.

### Experimental Results—Antiviral Activity and Toxicity of Coatings of Crosslinked Polymer Compound (III)

Coatings of the crosslinked polymer Compound (III), prepared and tested as described above, killed >99.9% of the adenovirus in as little as 30 seconds contact time. Moreover, Compound (III) was non-toxic to the HuH7 cells. The coatings of Compound (III) were essentially colorless, transparent, durable to contact with water and alcohol, and showed excellent adhesion to a variety of substrates such as PET and metal plates. Similar highly efficient antiviral activity and non-toxicity was observed with coatings of Compound (II) polymers which are also essentially colorless and transparent although with a slightly inferior durability against water and alcohol to the coatings of Compound (III).

The following examples further illustrate the advantages and versatility of the present technology.

### Example 5 Aqueous Solution Antiviral Efficiencies Against Adenovirus of HA-Q-PEI Polymers with Varied PEI Molecular Weights, Nitrogen Quaternization Groups, and Anionic Counter Ions

Various HA-Q-PEI (Hydroxy Alkyl Quaternary PEI) of the following formula:

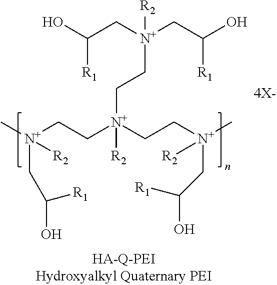

were prepared using analogous procedures as that which is described in Example 1 and analyzed for their antiviral (AV) efficiency against adenovirus as described in Example 4. Select data are shown in Table 2 (R₁=methyl for each polymer). These results demonstrate high antiviral efficiencies over a range of PEI molecular weights and with varied nitrogen quaternization groups (R₂) and anionic counterions (X—).

TABLE 2

| | | | | % AV |
|---|---|---|---|---|
| sample | MW | R₂ | X- | Efficiency |
| 2-1 | 600 | n-Hexyl | Bromide | 82 |
| 2-2 | 10,000 | n-Hexyl | Bromide | 97.29 |
| 2-3 | 100,000 | n-Hexyl | Bromide | 99.98 |
| 2-4 | 70,000 | n-Hexyl | Bromide | 99.93 |
| 2-5 | 70,000 | Benzyl | Chloride | 99.9 |
| 2-6 | 70,000 | Methyl | Iodide | 99.91 |
| 2-7 | 70,000 | n-Butyl | Bromide | 99.92 |
| 2-8 | 70,000 | —CH₂C(O)OCH₂CH₃ | Bromide | 99.94 |
| 2-9 | 70,000 | —CH₂C(O)Ph | Bromide | 99.42 |

### Example 6 Aqueous Solution Antiviral Efficiencies Against Adenovirus of HA-Q-PEI Polymers with Varied PEI Molecular Weights

Additional HA-Q-PEI polymers (R₁=methyl, R₂=hexyl, X=bromide) of the following formula:

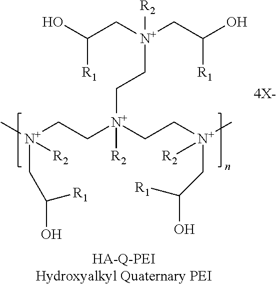

having various molecular weights were prepared using analogous procedures as that which is described in Example 1 and were analyzed for their antiviral (AV) efficiency against adenovirus as described in Example 4. Select data are shown in Table 3.

TABLE 3

| sample | MW (kDa) | % AV efficiency |
|---|---|---|
| 3-1 | 0.6 | 82.05 |
| 3-2 | 0.6 | 95.18 |
| 3-3 | 10 | 97.29 |
| 3-4 | 10 | 98.41 |
| 3-5 | 25 | 99.98 |
| 3-6 | 70 | 99.93 |
| 3-7 | 100 | 99.98 |
| 3-8 | 270 | 99.99 |
| 3-9 | 270 | 99.97 |

These results demonstrate that for this series of HA-Q-PEI polymers, the solution antiviral efficiency against Adenovirus increases as PEI molecular weight increases, leveling off at a maximum of >99% in the range of 25,000 to 270,000.

While these HA-Q-PEI polymers exhibit high solution antiviral efficiencies, they are not directly suitable for making durable water-resistant surface coatings due to their high degree of water solubility. Coating durability to solvents like water and ethanol is highly desirable so that the antimicrobial efficiency will be maintained and the need for frequent re-sanitizing of the surface is greatly reduced even after the surface is cleaned by washing.

### Example 7 Adenovirus Antiviral Efficiency of a PUA-Q-PEI-C Coating as a Function of the Weight Percent of n100 Crosslinker Used

Coatings of PUA-Q-PEI-C polymers of the following formula:

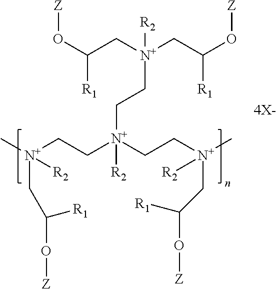

were prepared using analogous procedures as that which is described in Example 2, replacing the Octadecyl/Octyl Urethane Quaternary Ammonium PEI with a HA-Q-PEI (prepared from PEI: molecular weight=70,000 (branched), R₁=methyl, R₂=hexyl, X=bromide), and varying the amounts of crosslinker Z (DESMODUR® N100):

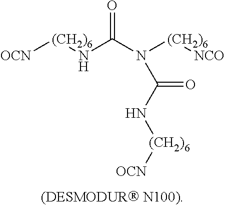

The antiviral efficiency against adenovirus (as described in Example 4) for these PUA-Q-PEI-C polymers was investigated. Select data are shown in Table 4.

TABLE 4

| sample | wt. % crosslinker* | % AV efficiency |
|---|---|---|
| 4-1 | 6.5 | 87.12 |
| 4-2 | 17.7 | 65.11 |
| 4-3 | 26.5 | 66.05 |
| 4-4 | 33.3 | 49.47 |
| 4-5 | 39.2 | 46.42 |
| 4-6 | 44.1 | 2.52 |

*wt. % with respect to PUA-Q-PEI-C polymer product

Cross-linking the HA-Q-PEI coating to form the polyurethane PUA-Q-PEI-C polymer coating improved water and ethanol durability of the coating, but, as can be seen by this example, this is associated with a significant decrease in the antiviral efficiency with increased amounts of cross-linking.

### Example 8 Antiviral Efficiency Against Adenovirus of HA-Q-PEI Polymer Aqueous Solution and of MUA-Q-PEI-A and MUA-Q-PEI-A100 Polymers as Uncross-Linked Coatings

MUA-Q-PEI-A polymers (R 3 =C18 alkyl or C8 alkyl) of the following formula:

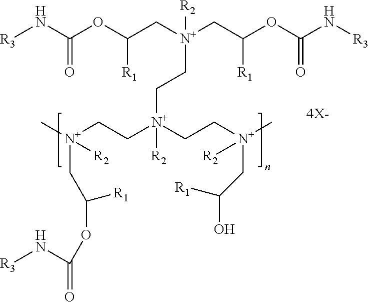

were prepared from HA-Q-PEI (prepared from PEI: molecular weight =70,000 (branched), R₁=methyl, R₂=benzyl) and a monoisocyanate mixture (7:3 ratio of octadecylisocyanate to octylisocyanate), wherein approximately 90% of HA-Q-PEI hydroxyl groups reacted with the monoisocyanate mixture (see similar protocol in Example 2). MUA-Q-PEI-A100 polymers were also similarly prepared, in which approximately 100% of the HA-Q-PEI hydroxyl groups reacted with the monoisocyanate mixture. Films of these MUA-Q-PEI-A and MUA-Q-PEI-A100 polymers were examined for their antiviral efficiency against adenovirus as described in Example 4. Select results are shown in Table 5.

TABLE 5

| | | contact time | % AV |
|---|---|---|---|
| sample | polymer system | (min) | efficiency |
| 5-1 | 1% water solution HA-Q-PEI | 30 | 97.41 |
| 5-2 | dry film MUA-Q-PEI-A | 30 | 99.99 |
| 5-3 | dry film MUA-Q-PEI-A | 1 | 99.84 |
| 5-4 | dry film MUA-Q-PEI-A | 0.5 | 99.49 |
| 5-5 | dry film MUA-Q-PEI-A100 | 30 | 99.99 |
| 5-6 | dry film MUA-Q-PEI-A100 | 1 | 99.98 |
| 5-7 | dry film MUA-Q-PEI-A100 | 0.5 | 99.91 |

These results indicate that the high solution antiviral efficiency of the HA-Q-PEI polymer was maintained and/or increased after reaction with the monoisocyanate mixture to form the coatings of the MUA-Q-PEI-A and the MUA-Q-PEI-A100 polymer. These results also demonstrate that the coatings exhibit >99% antiviral efficiency even at contact times as short as 30 seconds.

### Example 9 PUA-Q-PEI-B Coating Antiviral Efficiency Against Adenovirus and Coating Durability as a Function of Amount (Weight Percent) OF N3300 Polyisocyanate Crosslinker Used

PUA-Q-PEI-B polymers (R 3 =C 18 alkyl or C 8 alkyl) of the following formula:

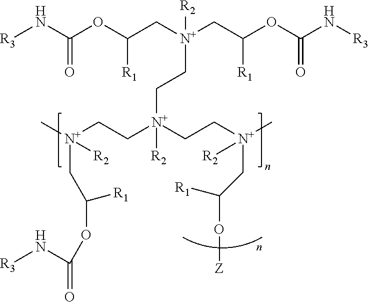

were prepared using analogous procedures as that which is described in Example 3. In particular, the HA-Q-PEI (prepared from PEI: molecular weight=25,000 (Hyper Branched), R₁=methyl, R₂=hexyl, X=bromide) was reacted with a monoisocyanate mixture (7:3 ratio of octadecylisocyanate to octylisocyanate), wherein approximately 90% of HA-Q-PEI hydroxyl groups reacted with the monoisocyanate mixture, before the remaining hydroxyl groups were reacted with varying amounts of crosslinker Z (DESMODUR® N3300):

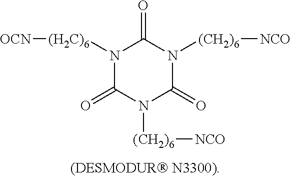

Coatings of these PUA-Q-PEI-B polymers were evaluated for their antiviral efficiency against adenovirus (as described in Example 4), water durability, and ethanol durability. The general procedure for measuring water and ethanol durability was to immerse center cross-cut coating samples in water or ethanol for ten minutes followed by gentle wiping of the sample with a cotton swab. An intact coating passed the test. Select data are shown in Table 6.

TABLE 6

| | wt. % | % AV | water | ethanol |
|---|---|---|---|---|
| Sample | crosslinker* | efficiency | durability | durability |
| 6-1 | 0 | 99.97 | fail | fail |
| 6-2 | 1.62 | 99.95 | pass | pass |
| 6-3 | 4.75 | 99.99 | pass | pass |
| 6-4 | 7.61 | 99.92 | pass | pass |
| 6-5 | 10.37 | 39.87 | pass | pass |

*wt. % crosslinker with respect to PUA-Q-PEI-B polymer product

This data suggest that the crosslinker is necessary to achieve good durability and that there was an optimum range of crosslinker level for these samples within which antiviral efficiency was >99% and above which antiviral efficiency was significantly decreased.

### Example 10 Retention of High Coating Antiviral Efficiency After Extended Time and Under More Extreme Environmental Conditions

PUA-Q-PEI-B polymers (R 3 =C 18 alkyl) of the following formula:

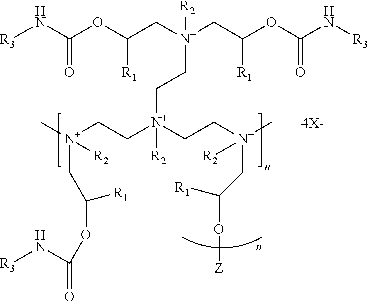

were prepared using analogous procedures as that which is described in Example 3. In particular, the HA-Q-PEI (prepared from PEI: molecular weight=70,000 (Branched), R₁=methyl, R₂=benzyl, X=chloride) was reacted with octadecylisocyanate, wherein approximately 85% of HA-Q-PEI hydroxyl groups reacted with the octadecylisocyanate, before the remaining hydroxyl groups were reacted with crosslinker Z (DESMODU Re N3300).

After coating and drying, the coating was optically clear, passed the water and ethanol durability tests (protocol as described in Example 9), was non-toxic to human liver cells, and exhibited 99.9% antiviral efficiency against adenovirus after a 30-second contact time (protocol as described in Example 4).

After storage of the coating for 105 days at ambient conditions, the coating still exhibited >98% antiviral efficiency and, after storage for 72 hours at 40° C./85% RH, the coating exhibited >99.73% antiviral efficiency. Further it was shown that these results were not dependent on the level of crosslinker used within the range of 1.62-7.61 weight percent.

In contrast, the commercial LIVINGUARD® face mask exhibited only 44% antiviral efficiency against adenovirus after 1 minute contact time and only 72% after 20 minutes contact time. When subjected to the same extended time and extreme conditioning tests, the LIVINGUARD® face mask efficiency dropped to 0% at 20 minute contact time after 105 days storage at ambient conditions and decreased from 72% to only 16% after 72 hours stored at 40° C./85% RH.

The antiviral and toxicity test procedures and the durability test procedures described above were also used to test several commercially available products for comparison purposes.

In contrast to coatings of the present technology, the quaternary PEI polymers shown below did not form colorless, transparent, durable water and alcohol resistant coatings and were only moderately antivirally active. The two latex quaternary polymers shown below exhibited antiviral activity but were toxic to HuH7 cells.

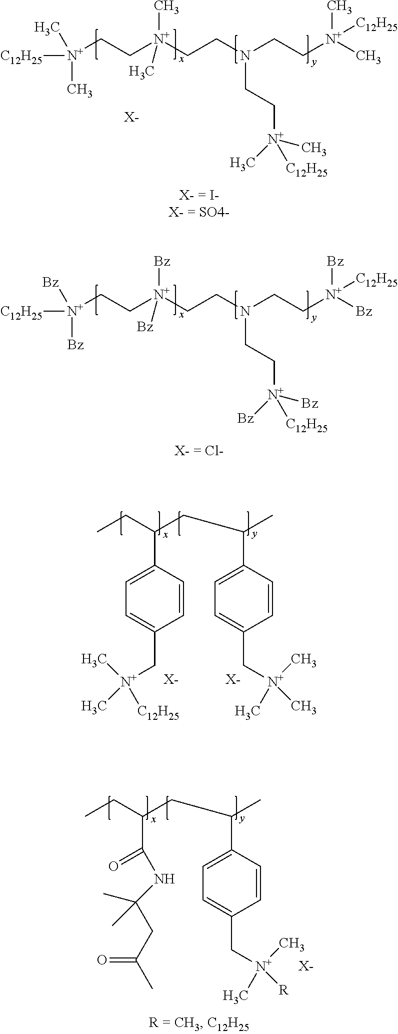

Mundex-W and Mundex-L-K (from Munditech, Germany) are two “self-disinfecting polymer emulsions” for treating surfaces. Both were found to be very weakly antiviral against adenovirus. Not unexpectedly, the water-based Mundex-W did not give a durable water or alcohol resistant surface coating. The solvent-based Mundex-L-K did give a more hydrophobic coating but its water or alcohol resistance was only marginal. Moreover, both of them were found toxic to HuH7 cells.

### Example 11 Assessment of the Antibacterial and Antifungal Activity of Additional Coatings of The Present Technology

PUA-Q-PEI-B polymers (R₃=C₁₈ alkyl or C₈ alkyl) of the following formula:

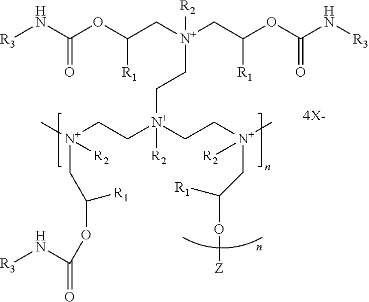

were prepared using analogous procedures as that which is described in Example 3. In particular, the HA-Q-PEI (prepared from PEI: molecular weight=25,000 (Hyperbranched) or 600 (Branched), R₁=methyl, R₂=n-hexyl, X=bromide) was reacted with a monoisocyanate mixture (7:3 ratio of octadecylisocyanate to octylisocyanate), wherein approximately 75% of HA-Q-PEI hydroxyl groups reacted with the monoisocyanate mixture, before the remaining hydroxyl groups were reacted with varying amounts of crosslinker Z (DESMODUR® N100).

Coatings of these PUA-Q-PEI-B polymers were evaluated for their antibacterial and antifungal efficiency. Select data are shown in Table 7.

TABLE 7

| Sample | Antimicrobial Efficiency | | | | | | | | |
|---|---|---|---|---|---|---|---|---|---|
| (wt. % | | | | | | | | Contact | |
| crosslinker) | A^{†} | B^{†} | C^{†} | D^{†} | E^{‡} | F^{‡} | G^{‡} | Time | |
| 1* | 99.43 | 99.78 | 0 | >99.99 | 4.5 | 8.8 | 0 | 10 | min |
| (18 wt. % | 99.2 | 99.29 | 47.38 | >99.99 | 33.93 | 24.14 | 27.56 | 1 | h |
| N100) | >99.99 | >99.99 | >99.99 | >99.98 | 98.74 | 98.55 | 94.24 | 24 | h |
| 2* | 99.32 | 99.04 | 0 | >99.99 | 0 | 16.82 | 0 | 10 | min |
| (5.5 wt. % | 97.23 | 76.47 | 2.63 | >99.99 | 16.82 | 16.82 | 12.9 | 1 | h |
| N100) | >99.99 | >99.99 | >99.99 | >99.98 | 99.99 | 99.99 | 99.94 | 24 | h |
| 3* | 99.04 | 99.23 | 0 | >99.99 | 4.5 | 10.87 | 2.28 | 10 | min |
| (4.5 wt. % | 98.38 | >99.99 | 0 | >99.99 | 27.56 | 33.93 | 33.93 | 1 | h |
| N100) | >99.99 | >99.99 | >99.99 | >99.98 | 99.65 | 99.47 | 98.49 | 24 | h |
| 4** | 99.09 | 99.81 | 0 | >99.99 | 89.28 | 92.06 | 80.94 | 10 | min |
| (6 wt. % | 93.63 | >99.99 | 81.11 | >99.99 | 99.98 | 99.97 | 99.97 | 1 | h |
| N100) | >99.99 | >99.99 | >99.89 | >99.98 | >99.99 | >99.99 | >99.99 | 24 | h |
| 5** | 99.1 | >99.99 | 0 | >99.99 | 98.85 | 98.41 | 80.94 | 10 | min |
| (4.5 wt. % | 99.45 | >99.99 | 70.55 | >99.99 | 99.96 | 99.95 | 99.91 | 1 | h |
| N100) | >99.99 | >99.98 | >99.89 | >99.98 | >99.99 | >99.99 | >99.99 | 24 | h |
| 6** | 98.6 | >99.99 | 0 | >99.99 | 98.22 | 98.55 | 96.98 | 10 | min |
| (3.5 wt. % | 96.54 | >99.99 | 0.79 | >99.90 | 99.93 | 99.92 | 99.92 | 1 | h |
| N100) | >99.99 | >99.98 | >99.98 | >99.87 | >99.99 | >99.99 | >99.99 | 24 | h |
| 7** | 99.02 | 99.02 | 0 | >99.99 | 98.26 | 98.26 | 96.84 | 10 | min |
| (12 wt. % | 99.88 | >99.99 | 0.5 | >99.90 | 99.92 | 99.92 | 99.8 | 1 | h |
| N100) | >99.99 | >99.99 | >99.89 | >99.87 | 99.99 | 99.99 | 99.99 | 24 | h |

^{†}Antimicrobial efficiency assessed using PN-EN ISO 22196:2011 standard at 35° C.
^{‡}Antimicrobial efficiency assessed using PN-EN ISO 21702:2019 standard at 25° C.
*PEI molecular weight = 25,000 daltons (Hyperbranched);
**PEI molecular weight = 600 daltons (Branched); A = Staphylococcus aureus (MRSA), B = Pseudomonas aeruginosa, C = Candida albicans, D = Clostridium difficile, E = Influenza A virus H3N2 , F = Influenza A virus H1N1, G = Human coronavirus 220E

### Example 12 Assessment of the Antibacterial and Antifungal Activity of the Coatings of the Present Technology

Similar highly efficient antiviral activity and non-toxicity was observed with coatings of polymers of general type of Compound (II) and Compound (III), with varied substituents on the PEI varied as shown below with polymer (2), polymer (2) fully reacted, and polymer (3):

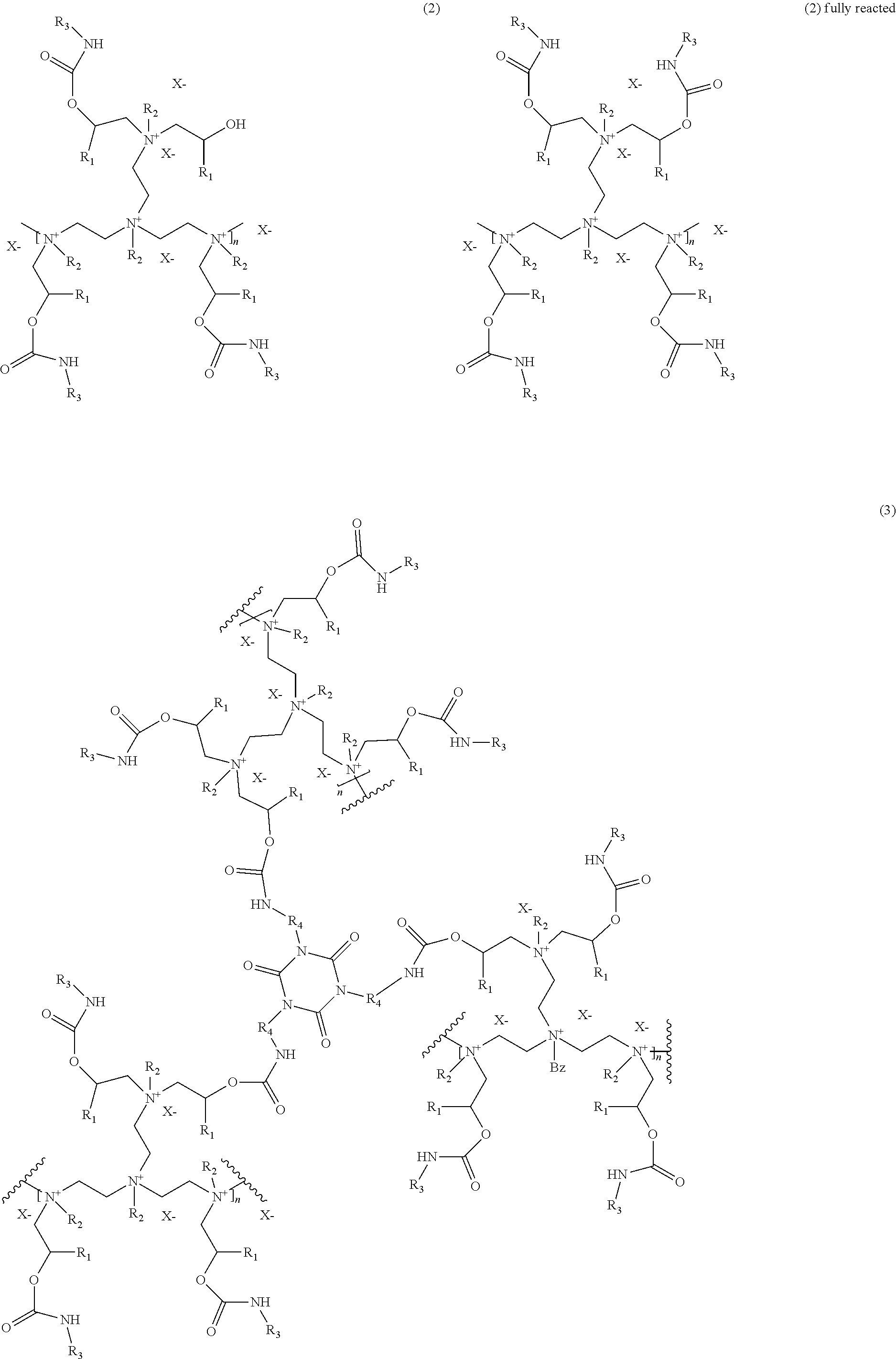

wherein

R₁=independently hydrogen, alkyl, alkylaryl, arylalkyl, aryl, alkyloxy, carboxy, hydroxyalkyloxyalkyl, and preferably methyl;

R₂=independently alkyl, arylalkyl, carboxyalkyl, hydroxyalkyl, alkoxyalkyl, hydroxyalkyloxyalkyl, and preferably benzyl, methyl, hexyl, ethylacetate, ethylbutyrate, and acetophenone;

R₃=independently alkyl, alkylaryl, aryl, arylalkyl, fluoro- or organosilicone-substituted and preferably a long chain alkyl such as C₈H₁₇ or C₁₈H₃₇;

R₄=independently alkylene including cyclic alkylene, alkylphenylene, such as C₆H₁₂, C₁₀H₁₇, C₁₃H₁₀, or C₁₃H₁₈, and preferably C₆H₁₂;

X−=anionic counterion to quaternary ammonium ions, such as chloride, bromide, iodide, sulfate, phosphate, borate . . . etc., and preferably chloride, bromide, and sulfate. The percent of hydroxyl groups converted to monoisocyanates in polymer (2) can be in the range 20% to 100% and preferably in the range 50% to 95%. Monourethane functionalized polymers (2), (2) fully reacted, and (3) can be derived from reactions with one or a blend of two or more monoisocyanates and preferably a blend of octylisocyanate and octadecylisocyanate in a molar ratio range of 1/9 to 5/5 and preferably 2/8 to 4/6. The cross-linking moiety shown in polymer (3) is derived from a polyisocyanate alkyl diisocyanate trimer such as hexamethylene diisocyanate trimer (HDI). Other possible crosslinkers include but are not limited to polyisocyanates having an average isocyanate functionality of 2 to 5 and preferably ones from the polyisocyanates derived from isophorone diisocyanate (IPDI), toluene isocyanate (TDI), methylene isocyanate (MDI), dicyclohexylmethane-4,4′-diisocyanate (DMDI), and other di-, tri-, and polyisocyanates. The weight percent of polyisocyanate to partially monourethane functionalized polymer (2) to form the cross-linked polymer (3) is preferably to be in the range of 1% to 30% and more preferably in the range of 3% to 10%. The PEI polymer backbone can be linear, branched, or hyperbranched and preferably be of average molecular weights (avg Mw) ranging from 0.6 to 1,000 kDa and more preferably 25 to 270 kDa.

Hydroxy Alkyl Quaternary Ammonium PEI polymers of the type of Compound (I), prepared as described above, are typically water soluble. In general, these exhibited high antiviral efficiency in solution. Some of these polymers tested exhibited a level of toxicity to HuH7 cells and some were non-toxic depending on the nature of the substituents and counterions.

### Sample Preparation and Test Method

For assessing the antibacterial activity of the polymer coatings of the present disclosure, polymer coatings were prepared as described previously for the antiviral testing. All samples and all accessories in the assessment were first disinfected by either high temperature autoclave treatment, alcohol cleaning or irradiation in a UV laminar flow chamber.

The test protocol used to determine antibacterial and antifungal activity was the procedure as described in ASTM-E2149-13a; a standard test method for determining antimicrobial activity of antimicrobial agents under dynamic contact conditions.

### Test Results

When coatings of the crosslinked polymer Compound (III), prepared and tested as described above against the bacteria E Coli, at least 99.9% of the bacteria were killed after incubation overnight at 37° C. Moreover, Compound (III), as described previously, was non-toxic to the HuH7 cells.

Similar highly efficient antibacterial activity and non-toxicity was observed with coatings of polymers of general type of Compound (II) and Compound (III), with varied substituents on the PEI varied as shown above.

Similar highly efficient antimicrobial activity was observed when testing was done against other bacteria including Staphylococcus aureus, Pseudomonas aeruginosa, Klebsiella pneomoniae, Andida albicans, Salmonella enterica and Streptococcus pneumoniae and also against the fungus Aspergillus niger.

In conclusion, the novel antimicrobial polymers of the present technology produce surface coatings that displayed the following properties: (i) highly antimicrobial activity against viruses, bacteria, and fungus; (ii) fast acting; (iii) long lasting; (iv) non-toxic and nonallergenic; (v) no materials leaching out of the coating; (vi) colorless and transparent as a surface coating; (vii) easy application to a wide range of surfaces and materials; (viii) durable surface coating resistant to water and common solvents; and (ix) easy and cost effective to produce. Accordingly, these novel antimicrobial polymers represent an improved class of antimicrobial polymers.

### REFERENCES

¹ Ellingson, K. D., et al. (2020). “Urban Hospital Study-Antimicrobial Surface Coating.” Clinical Infectious Diseases, 71(8): 1807-1813.
² Jarach, N., et al., (2020). “Polymers in the Medical Antiviral Front-Line”. Polymers, 12(8): 1727.
³ THE MERCK MANUAL OF DIAGNOSIS AND THERAPY, (2011). 19^{th} Edition, published by Merck Sharp & Dohme Corp., (ISBN 978-0-911910-19-3).
⁴ THE ENCYCLOPEDIA OF MOLECULAR CELL BIOLOGY AND MOLECULAR MEDICINE, Robert S. Porter et al. (eds.), published by Blackwell Science Ltd., 1999-2012 (ISBN 9783527600908).
⁵ MOLECULAR BIOLOGY AND BIOTECHNOLOGY: A COMPREHENSIVE DESK REFERENCE, (1995). Robert A. Meyers (ed.), published by VCH Publishers, Inc. (ISBN 1-56081-569-8).
⁶ IMMUNOLOGY, (2006). Werner Luttmann, published by Elsevier.
⁷ JANEWAY'S IMMUNOBIOLOGY, (2014). Kenneth Murphy, Allan Mowat, Casey Weaver (eds.), Taylor & Francis Limited, (ISBN 0815345305, 9780815345305).
⁸ LEWIN'S GENES XI, (2014). published by Jones & Bartlett Publishers (ISBN-1449659055).
⁹ Michael Richard Green and Joseph Sambrook, (2012). MOLECULAR CLONING: A LABORATORY MANUAL, 4th ed., Cold Spring Harbor Laboratory Press, Cold Spring Harbor, N.Y., USA (ISBN 1936113414).
¹⁰ Davis et al., (2012). BASIC METHODS IN MOLECULAR BIOLOGY, Elsevier Science Publishing, Inc., New York, USA (ISBN 044460149X).
¹¹ LABORATORY METHODS IN ENZYMOLOGY: DNA, (2013). Jon Lorsch (ed.) Elsevier (ISBN 0124199542).
¹² CURRENT PROTOCOLS IN MOLECULAR BIOLOGY (CPMB), (2014). Frederick M. Ausubel (ed.), John Wiley and Sons (ISBN 047150338X, 9780471503385).
¹³ CURRENT PROTOCOLS IN PROTEIN SCIENCE (CPPS), (2005). John E. Coligan (ed.), John Wiley and Sons, Inc.
¹⁴ CURRENT PROTOCOLS IN IMMUNOLOGY (CPI) (2003). Coligan, J. E., et al., (eds.) John Wiley and Sons, Inc. (ISBN 0471142735, 9780471142737).
¹⁵ Ikonen, N., et al., (2018). “Deposition of respiratory virus pathogens on frequently touched surfaces at airports.” BMC Infectious Diseases, 18(437): 1-8.
¹⁶ Geczi, Z., et al., (2018). “Antimicrobial Silver-Polyethyleneimine Polylactic Acid Polymer Composite Film for Coating Methacrylate-Based Denture Surfaces.” J. of Nanomaterials, 2018(6): 1-9.
¹⁷ Park, D., et al., (2006). “One-Step, Painting-Like Coating Procedures To Make Surfaces Highly and Permanently Bactericidal.” Biotechnology Prog. 22(2): 584-589.
¹⁸ Xue, Y. and Xiao, H. (2015). “Antibacterial/Antiviral Property and Mechanism of Dual-Functional Quaternized Pyridinium-Type Copolymer.” Polymers, 7(11): 2290-2303.
¹⁹ U.S. Pat. No. 5,783,502, “Virus Inactivating Coatings.” (Issued Jul. 21, 1998).
²⁰ Nurdin, N., et al., (1993). “Biocidal Polymers Active By Contact. II. Biological Evaluation of Polyurethane Coatings with Pendent Quaternary Ammonium Salts.” J. of Applied Polymer Science, 50: 663-670.
²¹ Chung, S., et al., (2016). “Antimicrobial Nanostructural Polyurethane Scaffolds.” Ch. 17 in ADVANCES IN POLYURETHANE BIOMATERIALS, Cooper S. L. and Guan, J. (eds.), Elsevier Ltd.
²² Park, D., et al., (2013). “Antiviral and Antibacterial Polyurethanes of Various Modalities.” Appl. Biochem. Biotechnol., 169: 1134-1146.
²³ Gao, B., et al., (2007). “Studies on the Preparation and Antibacterial Properties of Quaternized Polyethyleneimine.” J. Biomaterials Science, Polymer Edition, 18(5): 531-544.
²⁴ Klibanov, A., et al., (2006). “One-Step Painting-Like Coating Procedures to make Surfaces Highly and Permanently Bactericidal.” Biotechnol. Prog., 22(2): 584-589.
²⁵ Gao, B., et al., (2007). “Studies on the Preparation and Antibacterial Properties of Quaternized Polyethyleneimine.” J. Biomaterials Science, Polymer Edition, 18(5): 531-544.
²⁶ Id.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology described herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The foregoing written specification is considered to be sufficient to enable one skilled in the art to practice the present aspects and embodiments. The present aspects and embodiments are not to be limited in scope by examples provided, since the examples are intended as a single illustration of one aspect and other functionally equivalent embodiments are within the scope of the disclosure. Various modifications in addition to those shown and described herein will become apparent to those skilled in the art from the foregoing description and fall within the scope of the appended claims. The advantages and objects described herein are not necessarily encompassed by each embodiment. Those skilled in the art will recognize, or be able to ascertain using no more than routine experimentation, many equivalents to the specific embodiments described herein. Such equivalents are intended to be encompassed by the following claims.

1. An antimicrobial composition comprising a polymer, wherein:
the polymer comprises a reaction product of a polyethyleneimine oligomer, a multifunctional crosslinker, an alkylating agent, an optional monoisocyanate and an optional catalyst;
the polyethyleneimine oligomer comprises optionally substituted hydroxyethylene hydroxyalkylene functionality that reacts with one of or both of the optional monoisocyanate and the multifunctional crosslinker; and
nitrogen atoms present in the polyethyleneimine oligomer are at least partially quaternized by the alkylating agent.

2. The antimicrobial composition of claim 1, wherein the hydroxyalkylene functionality is optionally substituted with C₁-C₆ alkyl optionally substituted with a substituent selected from C₁-C₁₀ aryl and C₁-C₆ alkoxy optionally substituted with hydroxy; C₁-C₆ alkoxy; C₁-C₁₀ aryl optionally substituted with C₁-C₆ alkyl; and
carboxy.

3. The antimicrobial composition of claim 1, wherein the polyethyleneimine oligomer comprises a reaction product of a polyethyleneimine and a mono-epoxide, wherein the mono-epoxide is optionally substituted with C₁-C₆ alkyl optionally substituted with a substituent selected from C₆-C₁₀ aryl and C₁-C₆ alkoxy optionally substituted with hydroxy; C₁-C₆ alkoxy; C₁-C₁₀ aryl optionally substituted with C₁-C₆ alkyl; and carboxy.

4. The antimicrobial composition of claim 3, wherein the mono-epoxide is a C₁-C₆ epoxide.

5. (canceled)

6. The antimicrobial composition of claim 3, wherein the polyethyleneimine has a molecular weight of about 600 to about 270,000 daltons.

7. (canceled)

8. (canceled)

9. The antimicrobial composition of claim 3, wherein the polyethyleneimine has a ratio of primary to secondary to tertiary amines of about 1:2:1 to about 1:1:1.

10. (canceled)

11. The antimicrobial composition of claim 1, wherein the multifunctional crosslinker is a polyisocyanate.

12. The antimicrobial composition of claim 11, wherein the polyisocyanate has an average isocyanate functionality of 2 to 5.

13. (canceled)

14. (canceled)

15. The antimicrobial composition of claim 1, wherein at least 75% of the nitrogen atoms of the polyethyleneimine oligomer are quaternized by the alkylating agent.

16. The antimicrobial composition of claim 1, wherein the alkylating agent comprises one or more R₂-LG, wherein each R₂ is independently selected from C₁-C₆ alkyl optionally substituted with a substituent selected from hydroxy, C₁-C₆ alkoxy, carboxy, C₁-C₁₀ aryl, —C(O)O(C₁-C₆ alkyl), —C(O)—(C₁-C₁₀ aryl), and C₁-C₆ alkoxy optionally substituted with hydroxy; and each LG is a leaving group.

17. (canceled)

18. The antimicrobial composition of claim 1, wherein the monoisocyanate comprises one or more R₃-NCO, wherein each R₃ is independently selected from (1) Co-Cao alkyl optionally substituted with 1-3 substituents independently selected from halogen, —SiRₐ(OR_{b})(OR_{c}), and C₁-C₁₀ aryl; and (2) C₁-C₁₀ aryl optionally substituted with 1-3 substituents independently selected from halogen, C₁-C₆ alkyl, and —SiRₐ(OR_{b})(OR_{c});
wherein each Rₐ is independently C₁-C₆ alkyl; and each R_{b} and each R_{c} are independently selected from C₁-C₆ alkyl and —Si(C₁-C₆ alkyl)₃.

19.-22. (canceled)

23. The antimicrobial composition of claim 1, wherein the polymer has a chemical structure of compound (IV): 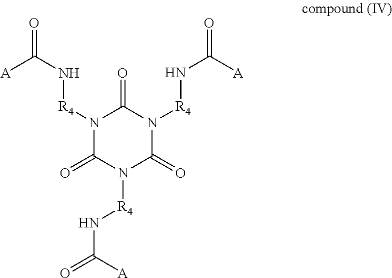
wherein:
each A is independently selected from 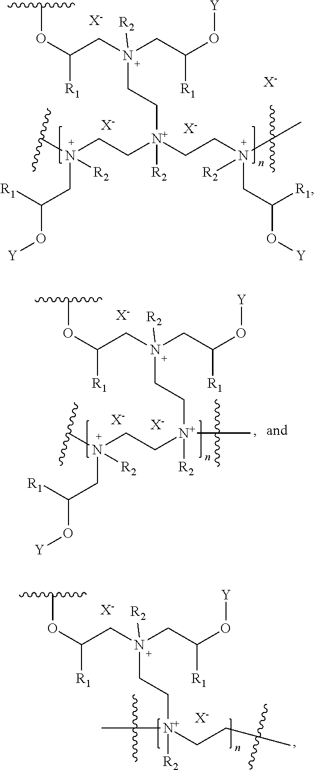
or a copolymer of any two or more thereof; and attachment of each A forms a carbamate linkage;
each Y is independently H or —C(O)—NHR₃;
each n is an integer independently selected from 1 to 3000;
each R₁ is independently selected from hydrogen; C₁-C₆ alkyl optionally substituted with a substituent selected from C₁-C₁₀ aryl and C₁-C₆ alkoxy optionally substituted with hydroxy; C₁-C₆ alkoxy; C₁-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₁-C₁₀ aryl, —C(O)O(C₁-C₆ alkyl), —C(O)—(C₁-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₁-C₁₀ aryl; (2) C₁-C₁₀ aryl optionally substituted with 1-3 substituents independently selected from halogen, C₁-C₆ alkyl, and —SiRₐ(OR_{b})(OR_{c}); and (3) 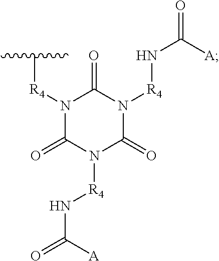
wherein each Rₐ is independently C₁-C₆ alkyl; and each R_{b} and each R_{c} are independently selected from C₁-C₆ alkyl and —Si(C₁-C₆ alkyl)3;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

24. The antimicrobial composition of claim 1, wherein the polymer has a chemical structure of compound (V): 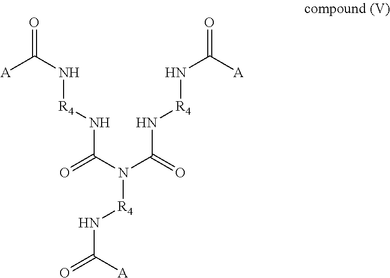
wherein:
each A is independently selected from 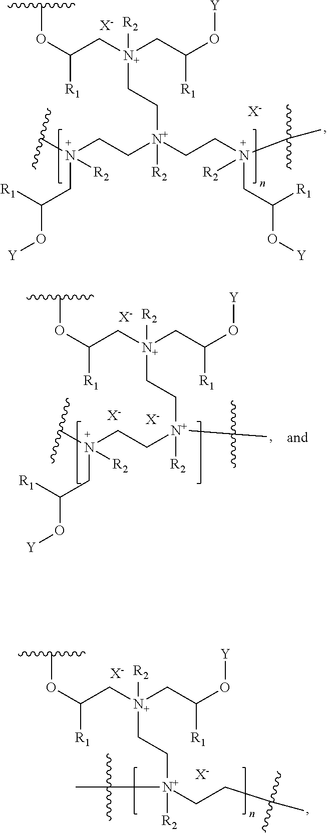
or a copolymer of any two or more thereof; and attachment of each A forms a carbamate linkage;
each Y is independently H or —C(O)—NHR₃;
each n is an integer independently selected from 1 to 3000;
each R₁ is independently selected from hydrogen; C₁-C₆ alkyl optionally substituted with a substituent selected from C₁-C₁₀ aryl and C₁-C₆ alkoxy optionally substituted with hydroxy; C₁-C₆ alkoxy; C₁-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₁-C₁₀ aryl, —C(O)O(C₁-C₆ alkyl), —C(O)—(C₁-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₁-C₁₀ aryl; (2) C₁-C₁₀ aryl optionally substituted with 1-3 substituents independently selected from halogen, C₁-C₆ alkyl, and —SiRₐ(OR_{b})(OR_{c}); and (3) 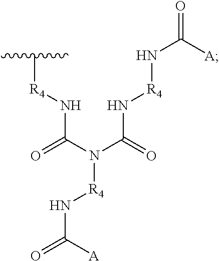
wherein each Rₐ is independently C₁-C₆ alkyl; and each R_{b} and each R_{c} are independently selected from C₁-C₆ alkyl and —Si(C₁-C₆ alkyl)₃;
each R₄ is independently C₁-C₁₀ alkylene optionally substituted with phenyl or a 3- to 8-member cycloalkyl ring; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

25.-36. (canceled)

37. An antimicrobial composition comprising compound (VI), compound (VII), or compound (VIII): 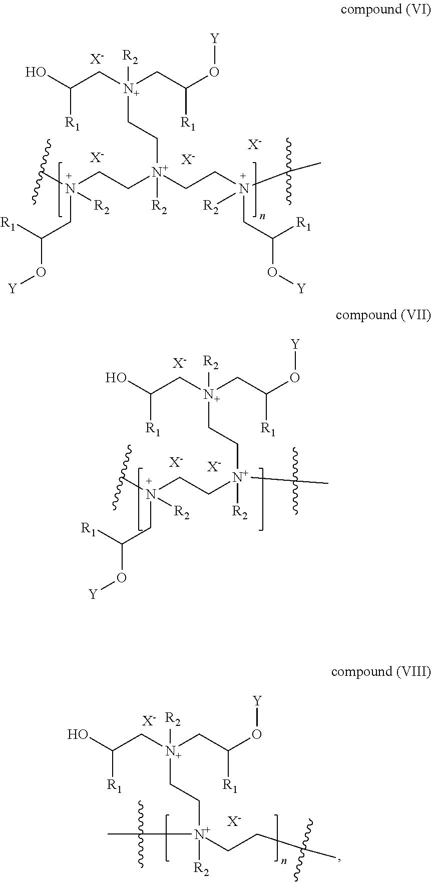
or a combination of any two or more thereof, or a copolymer of any two or more thereof, wherein:
each Y is independently H or —C(O)—NHR₃;
each n is an integer independently selected from 1 to 3000;
each R₁ is independently selected from hydrogen; C₁-C₆ alkyl optionally substituted with a substituent selected from C₆-C₁₀ aryl and C₁-C₆ alkoxy optionally substituted with hydroxy; C₁-C₆ alkoxy; C₆-C₁₀ aryl optionally substituted with C₁-C₆ alkyl; and carboxy;
each R₂ is independently selected from C₁-C₆ alkyl optionally substituted with a substituent selected from hydroxy, C₁-C₆ alkoxy, carboxy, C₆-C₁₀ aryl, —C(O)O(C₁-C₆ alkyl), —C(O)—(C₆-C₁₀ aryl), and C₁-C₆ alkoxy optionally substituted with hydroxy;
each R₃ is independently selected from (1) C₆-C₂₀ alkyl optionally substituted with 1-3 substituents independently selected from halogen, —SiRₐ(OR_{b})(OR_{c}), and C₆-C₁₀ aryl; and
(2) C₆-C₁₀ aryl optionally substituted with 1-3 substituents independently selected from halogen, C₁-C₆ alkyl, and —SiRₐ(OR_{b})(OR_{c}); wherein each Rₐ is independently C₁-C₆ alkyl; and each R_{b} and each R_{c} are independently selected from C₁-C₆ alkyl and —Si(C₁-C₆ alkyl)₃; and
each X⁻ is independently selected from the group consisting of acetate, halide, sulfate, sulfonate, phosphate, phosphonate, carbonate, silicate, hexafluorophosphate, hexafluoroantimonate, and borate, and their organo-substituted derivatives.

38.-75 (canceled)

76. An antimicrobial coating, coating fluid, or spraying fluid comprising a composition of claim 1.

77. A device, equipment, apparatus, or accessory comprising the coating, coating fluid or spraying fluid of claims 76.

78.-80. (canceled)

81. A personal care aid comprising the coating, coating fluid, or spraying fluid of claim 76.

82. (canceled)

83. A method to sanitize a surface, the method comprising applying a composition of claim 1 to the surface.

84. A method to reduce antimicrobial growth on a surface, the method comprising applying a composition of claim 1 to the surface.

85. A method to prevent antimicrobial growth on a surface, the method comprising applying a composition of claim 1 to the surface.

86. (canceled)

87. (canceled)
